(19) United States
(12) Patent Application Publication
(10) Pub. No.: US 2023/0068537 A1
(43) Pub. Date: Mar. 2, 2023

(54) POLYESTER-ACRYLIC HYBRID RESINS FOR COMPOSTABLE ADHESIVES

(71) Applicant: Avery Dennison Corporation, Mentor, OH (US)

(72) Inventors: Danny G. HARTINGER, Centre Hall, PA (US); Qiang LUO, Cypress, TX (US)

(21) Appl. No.: 17/904,389

(22) PCT Filed: Feb. 19, 2021
(86) PCT No.: PCT/US2021/018851

§ 371 Date: Aug. 17, 2022

Related U.S. Application Data
(60) Provisional application No. 62/978,364, filed on Feb. 19, 2020.

(51) Int. Cl. C08F 290/06; C09J 153/00

(52) U.S. Cl. CPC C08F 290/061; C09J 153/00

(57) ABSTRACT

Water-based and solvent-based polyester-(meth)acrylate hybrid polymers that may be utilized as compostable pressure-sensitive adhesives are provided. The aqueous dispersions exhibit an improved shelf-life and provide an improvement in handling and application or deposition/coating onto a variety of substrates, such as for making a pressure sensitive adhesive construct.

### CROSS-REFERENCE TO RELATED APPLICATION

The present application claims the benefit of U.S. Provisional Patent Application No. 62/978,364 filed Feb. 19, 2020, which is incorporated herein by reference in its entirety.

### TECHNICAL FIELD

Aqueous-based dispersions containing polyester macromer-(meth)acrylate hybrid polymer particles dispersed throughout an aqueous-based continuous phase and solvent-based polyester oligomer-(meth)acrylate hybrid polymers are described herein. The aqueous-based dispersions and the solvent-based hybrid polymers may be utilized as compostable pressure-sensitive adhesives and accordingly, the label constructions may be referred to as pressure sensitive labels. Labels constructed from compostable films in combination with the compostable adhesives are also described.

### BACKGROUND

A pressure sensitive adhesive (PSA) (also known as “self-adhesive” or “self-stick adhesive”) is a non-reactive adhesive that forms a bond at room temperature with a variety of dissimilar surfaces when light pressure is applied. No solvent, heat, or radiation is needed to activate the adhesive. PSAs may have applications in pressure-sensitive tapes and/or foils, general purpose labels, note pads, automobile trim, packaging, medical, and a wide variety of other products.

The present subject matter includes aqueous-based dispersions containing or consisting of particles of polyester macromer-(meth)acrylate hybrid polymer dispersed throughout an aqueous-based continuous phase and solvent-based polyester oligomer-(meth)acrylate hybrid polymers. The aqueous-based dispersions and solvent-based polyester-(meth)acrylate hybrid polymers described in this application may be utilized as compostable pressure-sensitive adhesives.

Pressure sensitive adhesive compositions are commonly manufactured by combining thermoplastic resins which are then blended with plasticizers, tackifiers crosslinkers, and/or other additives to produce materials with a wide range of pressure sensitive adhesive properties. Common tackifiers or plasticizers may also be derived from petroleum-based compounds though some are derived from naturally occurring feedstocks, such as wood, tall oil rosin and terpenes. Synthetic resin materials used in these adhesives include vinyl resins such as acrylic copolymers, natural rubbers, styrene-isoprene-styrene and styrene-butadiene-styrene block copolymers (SBCs), styrene-butadiene rubbers, olefin block copolymers (OBC) and polysiloxanes. Although these classes of polymers have excellent PSA properties, they are derived from non-renewable petroleum resources and do not degrade in the natural environment, contributing to the problem of plastic pollution, both in landfills and in the ocean. A substantial need has arisen for adhesives and, in particular, pressure sensitive adhesives, that are biodegradable/compostable in the appropriate environment including municipal composting facilities. Moreover, the use of water based systems results in the elimination of solvents; lower cost (water is relatively inexpensive compared to other solvents), no VOC generation during film drying, eliminates flammability issues with solvents, etc.

### SUMMARY

The difficulties and drawbacks associated with previous approaches are addressed in the present subject matter as follows.

Polyester-(meth)acrylate hybrid polymer compositions, and methods of making and using thereof are described herein. In some embodiments, the polyester-(meth)acrylate hybrid polymer compositions comprise or consist of a polyester portion covalently bound to a (meth)acrylate portion, wherein the polyester portion is present in the polyester-(meth)acrylate hybrid polymer at level of about 5% to about 95% by weight, based on the total weight of the polyester-(meth)acrylate hybrid polymer. The polyester portion further comprises or consists of an alternating copolymer comprising up to 50 repeating (AB) units or (BA) units or a combination thereof, wherein (A) is an epoxide and (B) is an anhydride (B), and the (meth)acrylate portion comprises or consists of a (meth)acrylate polymer. In some embodiments, the polyester-(meth)acrylate hybrid polymer is as described above and the weight ratio of the polyester portion to the (meth)acrylate portion is within the range of from about 5:95 to about 95:5 of the polyester-(meth)acrylate hybrid polymer including all intermittent values and ranges therein, e.g., from about 10:90 to about 95:5, from about 15:85 to about 95:5, from about 20:80 to about 95:5%, from about 25:75 to about 95:5, from about 30:70 to about 95:5%, from about 35:65 to about 95:5, from about 40:60 to about 95:5%, from about 45:55 to about 95:5, from about 50:50 to about 95:5%, from about 55:45 to about 95:5, from about 60:40 to about 95:5%, from about 65:35 to about 95:5%, from about 70:30 to about 95:5%, from about 75:25 to about 95:5, from about 80:20 to about 95:5%, from about 85:15 to about 95:5, and from about 90:10 to about 95:5% of the polyester-(meth)acrylate hybrid polymer.

In some embodiments, the polyester-(meth)acrylate hybrid polymer composition is as described above and further comprises one or more tackifiers.

In some embodiments, the polyester-(meth)acrylate hybrid polymer composition is as described above and comprises or consists of about 50-95 wt % polyester portion, about 5-50 wt % (meth)acrylate portion, and about 0-50 wt % one or more tackifiers, wherein the weight % of the components sum up to a total of 100% based on the total weight of the polyester-(meth)acrylate hybrid polymer composition.

In some embodiments, the polyester portion is as described above and comprises or consists of units that are prepared by the reaction of, or copolymerization of, or derived from, one or more ethylenically unsaturated monomers, one or more epoxides, and one or more anhydrides. Preferably, the one or more ethylenically unsaturated monomers comprise an α,β-unsaturated monomer, the one or more epoxides comprises a monoepoxide, and the one or more anhydrides is selected from the group consisting of an aliphatic anhydride, an aromatic anhydride, and combinations thereof.

The molecular weight of the polyester portion can vary based on the desired properties of the polyester. In some embodiments, the polyester portion is as described above and the weight average molecular weight (Mw) of the polyester portion is within a range of from about 300 to about 20,000 g/mol, or from about 300 to about 10,000 g/mol, or from about 300 to about 5,000 g/mol, or from about 500 to about 10,000 g/mol, or from about 1000 to about 6,000 g/mol as determined by gel permeation chromatography (GPC).

In some embodiments, the polyester portion is as described above and the polyester portion exhibits a glass transition temperature (Tg) within a range of from about −100° C. to about 150° C. or from about −50° C. to about 100° C., or from about −30° C. to about 50° C. measured by differential scanning calorimetry (DSC).

In some embodiments, the polyester portion is as described above and the polyester portion comprises a polyester macromer or a polyester oligomer.

In some embodiments, the polyester portion is as described above and the polyester portion contains one terminal ethylenically unsaturated group.

In some embodiments, the (meth)acrylate portion or (meth)acrylate polymer is as described above and is prepared by the reaction of, or copolymerization of, or derived from, at least one of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, and vinyl monomers.

In some embodiments, the (meth)acrylate portion or (meth)acrylate polymer is as described above and exhibits a glass transition temperature (Tg) within a range of from about −100° C. to about 150° C. or from about −70° C. to about 30° C., or from about −50° C. to about 0° C., or from about −40° C. to about −10° C. measured by differential scanning calorimetry (DSC).

In some embodiments, the (meth)acrylate portion or (meth)acrylate polymer is as described above and the weight average molecular weight (Mw) of the (meth)acrylate polymer is within a range of from about 5,000 to about 1,000,000 g/mol, or from about 50,000 to about 750,000 g/mol, or from about 100,000 to about 500,000 g/mol as determined by gel permeation chromatography (GPC).

In some embodiments, the polyester-(meth)acrylate hybrid polymer composition is as described above and further contains a photoinitiator moiety in the form of a distinct agent that is added to the composition, or a photoinitiator moiety bound to the polymer backbone, or a photoinitiator moiety formed in-situ by an association of materials or agents in the composition. In some embodiments, the photoinitiator moiety is bound to the (meth)acrylate polymer. The photoinitiator may be activated upon exposure to UV radiation to at least partially polymerize and/or crosslink the polyester-(meth)acrylate hybrid polymer composition.

The polyester-(meth)acrylate hybrid polymer composition described above may further contain one or more additives. Suitable additives include, but are not limited to, pigments, fillers, plasticizers, diluents, antioxidants, waxes, tackifiers, crosslinkers, and combinations thereof.

In some embodiments, the polyester-(meth)acrylate hybrid polymer composition is as described above and the polyester-(meth)acrylate hybrid polymer exhibits a single glass transition temperature (Tg) within a range of from about −100° C. to about 150° C. or from about −70° C. to about 30° C., or from about −50° C. to about 0° C., or from about −40° C. to about −10° C. measured by differential scanning calorimetry (DSC).

In an alternative embodiment, the polyester-(meth)acrylate hybrid polymer composition is as described above and the polyester portion and the (meth)acrylate portion or (meth)acrylate polymer are phase separated.

In some embodiments, the polyester-(meth)acrylate hybrid polymer composition is as described above and the weight average molecular weight (Mw) of the polyester-(meth)acrylate hybrid polymer is within a range of from about 5,000 to about 1,000,000 g/mol, or from about 50,000 to about 750,000, or from about 100,000 to about 500,000 g/mol as determined by gel permeation chromatography (GPC).

In an alternative embodiment, the polyester-(meth)acrylate hybrid polymer composition as described above is a solvent-based polyester-(meth)acrylate hybrid polymer composition prepared by the reaction of, or copolymerization of, or derived from, the (meth)acrylate polymer as described above optionally dissolved in an aprotic solvent, the one more epoxides, the one or more anhydrides, an epoxy catalyst, and optionally a free radical inhibitor to form a side chain of the polyester oligomer covalently bound to the (meth)acrylate polymer, wherein the (meth)acrylate polymer contains an acid and/or an alcohol functional group on the polymer backbone.

In another alternative embodiment, the polyester macromer-(meth)acrylate hybrid polymer contemplated in this application is a water-based polyester macromer-(meth)acrylate hybrid polymer comprising aqueous-based dispersions containing particles of the polyester macromer-(meth)acrylate hybrid polymer, as described above, dispersed throughout an aqueous-based continuous phase. In such embodiments, the polyester-(meth)acrylate hybrid polymer composition is prepared by the reaction of, or copolymerization of, or derived from, the polyester macromer and at least one ethylenically unsaturated monomer, wherein the reaction is a free radical polymerization reaction.

The size of the particles of the water dispersible composition described above can vary. In some embodiments, the polyester-(meth)acrylate hybrid polymer is as described above and has an average particle size diameter in the range of about 50 nm to about 600 nm measured by Dynamic Light Scattering.

Both the aqueous-based dispersions of the polyester-(meth)acrylate hybrid polymers and the solvent-based polyester-(meth)acrylate hybrid polymer compositions described above may be utilized as compostable pressure-sensitive adhesives and accordingly, the label constructions may be referred to as pressure sensitive labels. In one embodiment, polyester-(meth)acrylate hybrid polymer compositions as described above and one or more crosslinkers may be utilized to form compostable pressure sensitive adhesive. Methods for producing a polyester macromer usable for making the water-dispersible compositions described above are also described herein.

Polyester macromers usable for making the water-dispersible compositions of this application are also described herein. In some embodiments, the polyester macromer comprises or consists of alternating copolymer comprising up to 50 repeating (AB) units or (BA) units or a combination thereof, wherein (A) is an epoxide and (B) is an anhydride (B), and the (meth)acrylate portion comprising a (meth)acrylate polymer, wherein the repeating units are a reaction product of one or more ethylenically unsaturated monomers, one or more epoxides, one or more anhydrides, an epoxy catalyst, and optionally a free radical inhibitor.

In some embodiments, the polyester macromer described above contains one terminal ethylenically unsaturated group.

In some embodiments, the polyester macromer described above exhibits a glass transition temperature (Tg) within a range of from about −100° C. to about 150° C., or from about −50° C. to about 100° C., or from about −30° C. to about 50° C. measured by differential scanning calorimetry (DSC).

In some embodiments, the polyester macromer is as described above and the weight average molecular weight (Mw) of the polyester macromer is within a range of from about 300 to about 20,000 g/mol, or from about 300 to about 10,000 g/mol, or from about 300 to 5,000 g/mol as determined by gel permeation chromatography (GPC).

Methods for producing water-dispersible compositions containing polyester-(meth)acrylate hybrid polymer particles are also described herein.

Methods for producing solvent-based polyester-(meth)acrylate hybrid polymer compositions are also described herein.

The compositions and methods described herein overcome the limitations of current commercial products by creating hydrolyzable polyester macromer or oligomer. The macromer is used to make aqueous-based dispersions containing polyester-(meth)acrylate hybrid polymer particles while the polyester oligomer is grown as a side chain off of the (meth)acrylate polymer when making the solvent-based polyester-(meth)acrylate hybrid polymer. Both the water-based and solvent-based polyester-(meth)acrylate hybrid polymers may be utilized as compostable pressure-sensitive adhesives. During the polymerization step to form these polyester-(meth)acrylate hybrid polymers described herein, the large concentration of the polyester macromer or oligomer reduces the formation and concentration of long acrylic polymer chains (which are not compostable). In the water-based polyester-(meth)acrylate hybrid polymers compositions, gel permeation chromatography (GPC) shows the final polymer to be bimodal, but the pure acrylic portion (high MW) is small compared to the copolymer formed. The hydrolyzable polyester content (as opposed to high Tg, crystalline aromatic polyesters, like PET) makes the polymer compostable. Compostability is also enhanced by the low glass transition (Tg) of the copolymer and its amorphous nature. At room temperature, water and other solvents, have a hard time diffusing through a high Tg crystalline polymer such as PET (Tg is 81° C.).

### BRIEF DESCRIPTION OF DRAWINGS

FIG. 1 is a schematic diagram depicting an exemplary polyester macromer.

FIG. 2 is a schematic diagram depicting a different embodiment of an exemplary polyester macromer.

### DETAILED DESCRIPTION

### I. Definitions

The accompanying drawings are representative of some, but not all embodiments described herein. The claims should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

The term “compostable” within the context of adhesives, films, and labels as used herein may contain or include a material that may be placed into a composition of decaying materials and eventually turns into a nutrient-rich material. In certain embodiments, the term “compostable” as used herein may contain or include a plastic that undergoes degradation by biological processes during composting to yield carbon dioxide, water, inorganic compounds, and/or biomass via the action of naturally-occurring microorganisms, such as bacteria and fungi, at a rate consistent with other known compostable materials and that may leave no visible, distinguishable or toxic residue. In accordance with certain embodiments, the term “compostable” as used herein may contain or include a material that completely breaks down and returns to nature, such as decomposing into elements found in nature within a reasonably short period of time after disposal, such as within one year. The breakdown of “compostable” adhesives, films, and labels as described herein may be carried out by microorganisms present within, for example, industrial composting facilities. Materials may be identified as “compostable” by pass/fail tests, developed by international standards organization ASTM International, including, for example, D5338 and D6400, the contents of each are hereby incorporated by reference in their entirety.

As used herein, the terms “comprise(s),” “include(s),” “having,” “has,” “contain(s),” and variants thereof, are intended to be open-ended transitional phrases, terms, or words that do not preclude the possibility of additional acts or structure.

As used herein the term “aliphatic” is defined as including alkyl, alkenyl, alkynyl, halogenated alkyl, and cycloalkyl groups as described above. A “lower aliphatic” group is a branched or unbranched aliphatic group having from 1 to 10 carbon atoms.

As used herein the term “alkyl” refers to a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl, and the like. As used herein a “lower alkyl” group is a saturated branched or unbranched hydrocarbon having from 1 to 10 carbon atoms. In some embodiments, alkyl groups have 1 to 4 carbon atoms may be used. Alkyl groups may be “substituted alkyls” wherein one or more hydrogen atoms are substituted with a substituent such as halogen, cycloalkyl, alkoxy, amino, hydroxyl, aryl, or carboxyl.

As used herein the term “aryl” refers to any carbon-based aromatic group including, but not limited to, phenyl, naphthyl, and other suitable aryl compounds. As used herein the term “aryl” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorous. The aryl group may be substituted with one or more groups including, but not limited to, alkyl, alkynyl, alkenyl, aryl, halide, nitro, amino, ester, ketone, aldehyde, hydroxy, carboxylic acid, or alkoxy, or the aryl group may be unsubstituted.

As used herein the term “cycloalkyl” refers to a non-aromatic carbon-based ring composed of at least three carbon atoms. Examples of cycloalkyl groups include, but are not limited to, cyclopropyl, cyclobutyl, cyclopentyl, cyclohexyl, and the like. As used herein the term “heterocycloalkyl group” is a cycloalkyl group as defined above in which at least one of the carbon atoms of the ring is substituted with a heteroatom such as, but not limited to, nitrogen, oxygen, sulfur, or phosphorous.

As used herein the term “arylalkyl” or “aralkyl” refers to an alkyl group in which one of the hydrogen atoms of the alkyl is replaced by an aryl group.

“Heteroalkyl” means an alkyl group wherein at least one carbon atom of the otherwise alkyl backbone is replaced with a heteroatom, for example, O, S or N.

As used herein the term “macromer” refers to a reactive polyester oligomer (i.e., a functional oligomer) that contains one terminal ethylenically unsaturated group and has a weight average molecular weight (Mw) of within a range of from about 300 to about 20,000 g/mol as determined by gel permeation chromatography (GPC).

As used herein the term “oligomer” refers to a polyester oligomer that has a weight average molecular weight (Mw) within a range of from about 300 to about 20,000 g/mol as determined by gel permeation chromatography (GPC). For example, copolymerizing the polyester macromer and a mixture of one or more ethylenically unsaturated monomers described herein forms a polymer emulsion containing or consisting of a core-shell copolymer, the core-shell copolymer containing or consisting of a polyester oligomer core and a (meth)acrylate copolymer shell.

As used herein the term “bio-based” may comprise generally renewable materials such as any naturally-occurring material or any naturally-occurring material that has been modified to include one or more reactive functional groups, in which the material may be suitable for use as a prepolymer for the ultimate formation of a PSA. In certain embodiments, the term “bio-based” may comprise a variety of vegetable oils, functionally-modified vegetable oils, plant oils, functionally-modified plant oils, marine oils, functionally modified marine oils, or other ester of unsaturated fatty acids.

The term “dispersion” as used herein may comprise a two-phase system where one phase contains or includes discrete particulates, such as core-shell copolymers, distributed throughout a bulk substance, such as an aqueous-based phase, the particulates being the dispersed or internal phase while the bulk substance contains the continuous or external phase. The distribution of the dispersed phase may either be uniform or heterogeneous.

The term “water-based” or “aqueous-based” as used herein may contain or include a solvent containing at least a portion of water, or mostly water. In certain embodiments the term “aqueous-based” may consist of water alone, water and dispersing agents alone, water and catalysts alone, or water and dispersing agents and catalysts. In certain embodiments, the term “aqueous based” may comprise water, additives (e.g., catalyst, dispersing agents, etc.) and co-solvents, such as alcohols. In accordance with certain embodiments, the aqueous-based continuous phase is devoid of co-solvents.

The term “syrup composition” refers to a solution of a solute polyester macromer in one or more solvent monomer mix, the composition having a viscosity of from 500 to 10,000 cPs at room temperature. As used herein, the terms “room temperature” or “ambient temperature” are used interchangeably and refer to temperatures within the range of from about 150 to about 25° C., more more typically about 22° C. (72° F.).

As used herein, the term “liquid at room temperature” means a polymer that undergoes a degree of cold flow at room temperature. Cold flow is the distortion, deformation or dimensional change that takes place in materials under continuous load at temperatures within the working range. Cold flow is not due to heat softening.

The term “(meth)acrylate copolymer” used herein, refers to polymers formed from monomers of acrylates and/or methacrylates or any combination of these in a polymer composition wherein the monomers are esters of acrylic acid or methacrylic acid containing a polymerizable ethylenic linkage. This term also includes other classes of monomers with ethylenic linkage that can copolymerize with acrylate and methacrylate monomers.

As used herein, the term “polymer” may refer to a polymeric compound prepared by polymerizing monomers, whether of the same or a different type. The generic term “polymer” embraces the terms “homopolymer,” “copolymer”, and the like.

As used herein, the term “derived from” or “prepared by the reaction of” refers to the polymerization of the said monomers to form the product being referred to. That is, upon polymerization, the monomer, as present in the polymer, is chemically different than the unreacted monomer.

As used herein, the term “inhibitor” refers to a molecule that terminates the growth of free radical polymerization by interacting with the radical terminus of the polymer chain so as to remove its energy for continued reaction with monomer.

As used herein, the term “ethylenically unsaturated” when used to described monomers or groups refers to monomers or groups that contain terminal ethylene groups (H₂C═CH—).

As used herein, the term “cure” refers to polymerize and/or crosslink.

As used herein, the term “protic compound” includes chemical compounds having O—H or N—H bonds. In this application, a protic compound is capable of reacting with either the anhydride or the epoxide. For example, when forming the polyester macromer, a protic ethylenically unsaturated compound (such as (meth)acrylic acid and/or hydroxyl alkyl (meth)acrylates) may be used to initiate the macromer polymerization and provide the terminal ethylenic unsaturation. In some embodiments, other protic compounds (such as choline chloride or N,N-dimethylethanol amine) may be used as both an initiator of the macromer polymerization and a catalyst for the epoxy reaction (e.g., the reaction of the epoxide and the anhydride). Non-limiting examples of the protic compounds useful in the polymerization of the polyester macromer include tertiary amine-containing protic compounds (such as N,N-dimethylethanol amine), tertiary phosphine-containing protic compounds, quaternary ammonium-containing protic compounds (such as choline chloride), quaternary phosphonium-containing protic compounds, or such like compounds. In such embodiments, the protic compound would become part of the polyester macromer and the reaction would not require the addition of another or separate catalyst. Importantly, such an embodiment would not require an additional process to extract a compound or catalyst that would be undesirable in food contact applications.

As used herein, the term “aprotic solvent” refers to aromatic solvent selected from one or more of toluene, xylene and naphthalene or an aliphatic hydrocarbon solvent selected from hexane, heptane, octane, nonane, decane. Other suitable solvents include a ketone or an ester or a mixture thereof. Non-limiting examples of suitable ketones are methyl ethyl ketone (MEK), methyl n-propyl ketone (MPK), methyl isopropyl ketone (MIPK), methyl n-butyl ketone (MBK), methyl isobutyl ketone (MIBK), methyl n-amyl ketone (MAK), methyl isoamyl ketone (MIAK), diisobutyl ketone (DIBK), C11 ketone. Non-limiting examples of suitable esters are ethyl acetate, propyl acetate, butyl acetate, isobutyl acetate, t-butyl acetate, propyl propionate, butyl propionate, isobutyl isobutyrate, 2-ethoxy ethyl acetate, propylene glycol monomethyl ether acetate.

### II. Polyester-(Meth)acrylate Hybrid Polymer

Generally, present subject matter provides polyester-(meth)acrylate hybrid polymers containing or consisting of a polyester portion covalently bound to a (meth)acrylate portion. The polyester portion comprising a polyester macromer or polyester oligomer and the (meth)acrylate portion comprising a (meth)acrylate polymer. The polyester portion is present in the polyester-(meth)acrylate hybrid polymer at level of about 5% to about 95% by weight, based on the total weight of the polyester-(meth)acrylate hybrid polymer, including all intermittent values and ranges therein, e.g., from about 10% to about 95%, from about 15% to about 95%, from about 20% to about 95%, from about 25% to about 95%, from about 30% to about 95%, from about 35% to about 95%, from about 40% to about 95%, from about 45% to about 95%, from about 50% to about 95%, from about 55% to about 95%, from about 60% to about 95%, from about 65% to about 95%, from about 70% to about 95%, from about 75% to about 95%, from about 80% to about 95%, from about 85% to about 95%, and from about 90% to about 95% of the polyester-(meth)acrylate hybrid polymer.

In some embodiments, the polyester-(meth)acrylate hybrid polymer is as described above and the weight ratio of the polyester portion to the (meth)acrylate portion is within the range of from about 5:95 to about 95:5 of the polyester-(meth)acrylate hybrid polymer, including all intermittent values and ranges therein, e.g., from about 10:90 to about 95:5, from about 15:85 to about 95:5, from about 20:80 to about 95:5%, from about 25:75 to about 95:5, from about 30:70 to about 95:5%, from about 35:65 to about 95:5, from about 40:60 to about 95:5%, from about 45:55 to about 95:5, from about 50:50 to about 95:5%, from about 55:45 to about 95:5, from about 60:40 to about 95:5%, from about 65:35 to about 95:5%, from about 70:30 to about 95:5%, from about 75:25 to about 95:5, from about 80:20 to about 95:5%, from about 85:15 to about 95:5, and from about 90:10 to about 95:5% of the polyester-(meth)acrylate hybrid polymer.

In some embodiments, the polyester-(meth)acrylate hybrid polymer is as described above and the polyester portion contains or consists of a majority proportion of the polyester-(meth)acrylate hybrid polymer.

In some embodiments, the polyester-(meth)acrylate hybrid polymer is as described above and the weight ratio of the polyester portion to the (meth)acrylate portion is within the range of from about 50:50 to about 95:5 of the polyester-(meth)acrylate hybrid polymer.

In some embodiments, the polyester-(meth)acrylate hybrid polymer is as described above and the weight ratio of the polyester portion to the (meth)acrylate portion is within the range of from about 70:30 to about 95:5 of the polyester-(meth)acrylate hybrid polymer.

During the polymerization process to form the water-based and the solvent-based polyester-(meth)acrylate polymers contemplated in this application, the large concentration of the polyester portion (macromer or oligomer) reduces the formation and concentration of long acrylic polymer chains (which are not compostable).

In some embodiments, the polyester-(meth)acrylate hybrid polymer is as described above and further contain one or more tackifiers.

In some embodiments, the polyester-(meth)acrylate hybrid polymer is as described above and comprises or consists of (1) about 50-95 wt % polyester portion, (2) about 5-50 wt % (meth)acrylate portion; and (3) about 0-50 wt % one or more tackifiers, wherein the weight % of the components sum up to a total of 100% based on the total weight of the polyester-(meth)acrylate hybrid polymer composition.

Specifically, the present subject matter provides aqueous-based dispersions containing or consisting of particles of polyester-(meth)acrylate hybrid polymers as described above dispersed throughout an aqueous-based continuous phase and solvent-based polyester-(meth)acrylate hybrid polymers formed in aprotic solvents. The water-based polyester-(meth)acrylate hybrid polymers contain or consist of a polyester macromer covalently bound to a (meth)acrylate polymer while the solvent-based polyester-(meth)acrylate hybrid polymers contain or consist of a polyester oligomer grown as a side chain off of the (meth)acrylate polymer to form a polyester oligomer covalently bound to a (meth)acrylate polymer.

A. Polyester Portion (Polyester Macromer or Oligomer)

The polyester portion described herein contains or consists of an alternating copolymer comprising up to 50 repeating (AB) or (BA) units or a combination thereof, wherein (A) is an epoxide and (B) is an anhydride (B), and the (meth)acrylate portion comprising a (meth)acrylate polymer. In some embodiments, the polyester portion comprises 1 to 20 repeating (AB) or (BA) units or a combination thereof, preferably 1 to 10 repeating (AB) or (BA) units or a combination thereof. In some embodiments, the polyester portion is as described above and contains or consists of a single polyester portion or a mixture of polyester portions. In some embodiments, the polyester portions in the mixture have the same chemical composition but different molecular weights, different chemical compositions but the same or similar molecular weights, different chemical compositions and different molecular weights, and combinations thereof.

The molecular weight of the polyester portion can vary based on the desired properties of the polyester portion, the polyester-(meth)acrylate hybrid polymer, or compositions containing the same. In some embodiments, the polyester portion is as described above and the weight average molecular weight (Mw) of the polyester oligomer is within a range of from about 300 g/mol to about 20,000 g/mol, including all intermittent values and ranges therein, or in the alternative, from about 500 g/mol to about 10,000 g/mol, including all intermittent values and ranges therein, or in the alternative, from about 500 g/mol to about 5,000 g/mol, including all intermittent values and ranges therein, or in the alternative, from about 1000 g/mol to about 6,000 g/mol, including all intermittent values and ranges therein, as determined by gel permeation chromatography (GPC).

In some embodiments, the polyester portion is as described above and exhibits a glass transition temperature (Tg) within a range of from about −100° C. to about 150° C., including all intermittent values and ranges therein, or in the alternative, from about −50° C. to about 100° C., including all intermittent values and ranges therein, or in the alternative, from about −30° C. to about 50° C., including all intermittent values and ranges therein, measured by differential scanning calorimetry (DSC).

Generally, the polyester portion is as defined above and is prepared by the reaction of, or derived from, one or more ethylenically unsaturated monomers, one or more epoxides, and one or more anhydrides in the presence of an epoxy catalyst and optionally a free radical inhibitor.

1. Ethylenically Unsaturated Monomers

In some embodiments, the one or more ethylenically unsaturated monomers is or contains an α,β-unsaturated monomer. In some embodiments, the one or more ethylenically unsaturated monomers includes those selected from acrylic acid, methacrylic acid, crotonic acid, hydroxyl alkyl (meth)acrylate, glycidyl (meth)acrylate, (meth)acrylic anhydride, and combinations thereof. In some embodiments, the one or more ethylenically unsaturated monomers contain or is an α,β-unsaturated acid. In some embodiments, the one or more ethylenically unsaturated monomers contains or is a (meth)acrylic acid. In some embodiments, the one or more ethylenically unsaturated monomers contains or is a hydroxyl alkyl (meth)acrylate. Suitable hydroxyl alkyl (meth)acrylate include, but are not limited to hydroxyethyl (meth)acrylate, hydroxypropyl (meth)acrylate, hydroxybutyl (meth)acrylate, and combinations thereof.

2. Epoxides

In some embodiments, the ethylenically unsaturated monomer is as described above and the one or more epoxides contains or is a monoepoxide. In some embodiments, the one or more epoxides includes those selected from aliphatic alcohol glycidyl ethers having 1 to 22 carbon atoms, glycidyl esters of aliphatic carboxylic acids containing from 1 to 22 carbon atoms, glycidyl esters of aromatic carboxylic acids, alkyl substituted glycidyl esters of aromatic carboxylic acids, aryl substituted glycidyl esters of aromatic carboxylic acids, aromatic glycidyl ethers, alkyl substituted aromatic glycidyl ethers, aryl substituted aromatic glycidyl ethers, terpene based mono-epoxides, alpha olefin based mono-epoxides, oxetane, alkylated derivatives of oxetanes, epoxidized mono-unsaturated fatty acid esters, epoxidized mono-unsaturated fatty alcohol esters, glycidyl amine compound(s), and combinations thereof.

Non-limiting examples of the aliphatic alcohol glycidyl ethers includes those selected from butyl glycidyl ether, 2-ethylhexyl glycidyl ether, C8-C10 alcohol glycidyl ethers, C12-C14 alcohol glycidyl ethers, and combinations thereof.

Non-limiting examples of the glycidyl esters of aliphatic carboxylic acids includes a glycidyl ester of neodecanoic acid or rosin acid.

Non-limiting examples of the glycidyl esters of aromatic carboxylic acids includes a glycidyl ester of benzoic acid.

Non-limiting examples of the aromatic glycidyl ethers are selected from the group consisting of phenyl glycidyl ether, (o,m,p)-cresol glycidyl ethers, p-tert butyl phenol glycidyl ether, cardanol based glycidyl ethers, and combinations thereof.

3. Anhydrides

In some embodiments, the ethylenically unsaturated monomer and the epoxide are as described above and the one or more one or more anhydrides is selected from an aliphatic anhydride, an aromatic anhydride, and combinations thereof. Suitable anhydrides include, but are not limited to succinic anhydride, maleic anhydride, glutaric anhydride, phthalic anhydride, tetrahydrophthalic anhydride, hexahydrophthalic anhydride, methyl hexahydrophthalic anhydride, nadic anhydride, methyl nadic anhydride, naphthalic anhydride, trimellitic anhydride, diglycolic anhydride, and combinations thereof.

4. Epoxy Catalysts

The polyester portion described herein can be prepared by polymerizing one or more ethylenically unsaturated monomers, one or more epoxides, and one or more anhydrides as described above in the presence of an epoxy catalyst and a free radical inhibitor to form a terminally ethylenically unsaturated polyester macromer copolymer. Suitable epoxy catalysts include, but are not limited to tertiary amines, tertiary phosphines, quaternary ammonium salts, quaternary phosphonium salts, imidazoles, dicyandiamide, lewis acids (boron trifluoride complexes), UV super acid complexes, organic acid hydrazides, and combinations thereof. In some embodiments, the epoxy catalyst serves the dual functions of both initiating the macromer polymerization and catalyzing the reaction between the epoxides and the anhydrides. In such embodiments, the epoxy catalyst would be incorporated into the backbone of the polyester macromer and the reaction would not require the addition of another or separate catalyst. Suitable dual function epoxy catalysts include, but are not limited to tertiary amine-containing protic compounds (such as N,N-dimethylethanol amine) and quaternary ammonium-containing protic compounds (such as choline chloride). Importantly, because the epoxy catalyst would be incorporated into the polyester macromer backbone, such embodiments advantageously would not require an additional process to extract a catalyst that would be undesirable in applications such as food contact applications. In such embodiments, the epoxy catalyst is preferably a material that can be used safely for adhesives and/or labels that will come in contact with food.

5. Free Radical Inhibitors

The polyester portion described herein can be prepared by polymerizing one or more ethylenically unsaturated monomers, one or more epoxides, and one or more anhydrides in the presence of an epoxy catalyst as described above and optionally a free radical inhibitor to form a terminally ethylenically unsaturated polyester macromer copolymer. Suitable free radical inhibitors include, but are not limited to, hydroquinone, para-benzoquinone, hydroquinone monomethyl ether, toluhydroquinone (THQ), mono-tert-butyl hydroquinone (MTBHQ), 2,5-di-tert-butylhydroquinone (DTBHQ), butylated hydroxytoluene (BHT), and combinations thereof. Butylated hydroxytoluene (BHT) is preferred for applications where the subject matter described herein will come in contact with food.

The polyester portion described above can be a polyester macromer or a polyester oligomer. In some embodiments, the polyester portion is as described and contains one terminal ethylenically unsaturated group.

B. (Meth)acrylate Portion or (Meth)acrylate Polymer

In some embodiments, the polyester portion is as described above and the (meth)acrylate portion or (meth)acrylate polymer is prepared or derived from at least one monomer selected from the group consisting of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, and vinyl monomers. Suitable monomers include, but are not limited to one or more monomer units selected from acrylic acid, methacrylic acid, crotonic acid, crotonate esters, itaconic acid, itaconate esters, fumaric acid, fumarate esters, maleic acid, maleate esters, maleic anhydride, hydroxyl alkyl (meth)acrylate, hydroxyethyl (meth)acrylate, hydroxypropyl (meth)acrylate, hydroxybutyl (meth)acrylate, glycidyl (meth)acrylate, (meth)acrylic anhydride, isobornyl (meth)acrylate, aminoethyl methacrylate, N,N-dimethyl aminoethyl methacrylate, urea/ureido methacrylate, acrylonitrile, methacrylonitrile, acrylamide, methacrylamide, N,N-dimethylacrylamide, methyl acrylate, methyl methacrylate, ethyl acrylate, ethyl methacrylate, butyl acrylate, butyl methacrylate, propyl acrylate, propyl methacrylate, 2-ethylhexyl acrylate, 2-ethylhexyl methacrylate, lauryl acrylate, lauryl methacrylate, iso-octyl acrylate, iso-octyl methacrylate, iso-decyl acrylate, iso-decyl methacrylate, stearyl acrylate, stearyl methacrylate, vinyl propionate, styrene, alkyl-substituted styrenes, vinyl acetate, vinyl chloride, N-vinyl pyrrolidone, and combinations thereof.

Photoinitiators

In some embodiments, the (meth)acrylate polymer is as defined above and further contains an additional agent that is admixed and/or covalently bound to the (meth)acrylate polymer, wherein the additional agent is or contains a photoinitiator moiety. The additional agent may contain the photoinitiator moiety at the time it is admixed or covalently bound to the (meth)acrylate polymer (e.g., during polymerization or post polymerization) or the photoinitiator moiety can be generated in-situ. Suitable photoinitiators include, but are not limited to, acetophenone or derivatives thereof, benzophenone or derivatives thereof, anthraquinone or derivatives thereof, benzile or derivatives thereof, thioxanthone or derivatives thereof, xanthone or derivatives thereof, a benzoin ether or derivatives thereof, an alpha-ketol or derivatives thereof, and combinations thereof. In some embodiments, the photoinitiator is activatable upon exposure to UV radiation to at least partially polymerize and/or crosslink the composition.

In some embodiments, the (meth)acrylate polymer is as described above and exhibits a glass transition temperature (Tg) within a range of from about −100° C. to about 150° C., including all intermittent values and ranges therein, or in the alternative, from about −70° C. to about 30° C., including all intermittent values and ranges therein, or in the alternative, from about −50° C. to about 0° C., including all intermittent values and ranges therein, or in the alternative, from about −40° C. to about −10° C., including all intermittent values and ranges therein measured by differential scanning calorimetry (DSC).

In some embodiments, the (meth)acrylate polymer is as described above and the weight average molecular weight (Mw) of the (meth)acrylate polymer is within a range of from about 5,000 to about 1,000,000 g/mol, including all intermittent values and ranges therein, or in the alternative, from about 50,000 to about 750,000 g/mol, including all intermittent values and ranges therein, or in the alternative, from about 100,000 to about 500,000 g/mol, including all intermittent values and ranges therein, as determined by gel permeation chromatography (GPC).

Polyester-(Meth)acrylate Hybrid Polymer

As previously stated, the present subject matter provides polyester-(meth)acrylate hybrid polymers containing or consisting of a polyester portion covalently bound to a (meth)acrylate portion. The polyester portion comprising a polyester macromer or polyester oligomer and the (meth)acrylate portion comprising a (meth)acrylate polymer, the details of which have been provided above.

Additives

In some embodiments, the polyester-(meth)acrylate hybrid polymer composition is as described above and may further contain or consist of additives. Suitable additives include, but are not limited to pigments, fillers, plasticizers, diluents, antioxidants, waxes, tackifiers, crosslinkers, and combinations thereof.

In some embodiments, the polyester-(meth)acrylate hybrid polymer is as described above and exhibits a single glass transition temperature (Tg) within a range of from about −100° C. to about 150° C., including all intermittent values and ranges therein, or in the alternative, from about −70° C. to about 30° C., including all intermittent values and ranges therein, or in the alternative, from about −50° C. to about 0° C., including all intermittent values and ranges therein, or in the alternative, from about −40° C. to about −10° C., including all intermittent values and ranges therein measured by differential scanning calorimetry (DSC).

In some embodiments, the polyester-(meth)acrylate hybrid polymer is as described above and the polyester portion and the (meth)acrylate portion or (meth)acrylate polymer are phase separated. In such embodiments, the polyester-(meth)acrylate hybrid polymer exhibits at least two glass transition temperatures (Tg) within a range of from about −100° C. to about 150° C. measured by differential scanning calorimetry (DSC), wherein the glass transition temperature (Tg) of the polyester portion is within a range of from about 0° C. to about 150° C., including all intermittent values and ranges therein, or in the alternative, from about 25° C. to about 130° C., including all intermittent values and ranges therein, or in the alternative, from about 50° C. to about 110° C., including all intermittent values and ranges therein, and the glass transition temperature (Tg) of the (meth)acrylate portion or (meth)acrylate polymer is within a range of from about −100° C. to about 150° C., including all intermittent values and ranges therein, or in the alternative, from about −70° C. to about 30° C., including all intermittent values and ranges therein, or in the alternative, from about −50° C. to about 0° C., including all intermittent values and ranges therein, or in the alternative, from about −40° C. to about −10° C., including all intermittent values and ranges therein, measured by differential scanning calorimetry (DSC).

In some embodiments, the polyester-(meth)acrylate hybrid polymer is as described above and the weight average molecular weight (Mw) of the polyester-(meth)acrylate hybrid polymer is within a range of from about 5,000 to about 1,000,000 g/mol, including all intermittent values and ranges therein, or in the alternative, from about 50,000 to about 750,000 g/mol, including all intermittent values and ranges therein, or in the alternative, from about 100,000 to about 500,000 g/mol, including all intermittent values and ranges therein, as determined by gel permeation chromatography (GPC).

Solvent-Based Polyester-(Meth)acrylate Hybrid Polymer

In an alternative embodiment, the polyester-(meth)acrylate hybrid polymer composition is as described above and the polyester-(meth)acrylate hybrid polymer is a solvent-based polyester-(meth)acrylate hybrid polymer composition prepared by the reaction of, or copolymerization of, or derived from, the (meth)acrylate polymer as described above optionally dissolved in an aprotic solvent, the one more epoxides, the one or more anhydrides, an epoxy catalyst, and optionally a free radical inhibitor to form a side chain of the polyester oligomer covalently bound to the (meth)acrylate polymer. Preferably, the (meth)acrylate polymer contains an acid and/or an alcohol functional group on the polymer backbone.

Suitable epoxy catalysts include, but are not limited to tertiary amines, tertiary phosphines, quaternary ammonium salts, quaternary phosphonium salts, imidazoles, dicyandiamide, lewis acids (boron trifluoride complexes), UV super acid complexes, organic acid hydrazides, alkali metal carboxylates, and combinations thereof. Preferably, the aprotic solvent is an aromatic solvent selected from one or more of toluene, xylene and naphthalene or an aliphatic hydrocarbon solvent selected from hexane, heptane, octane, nonane, decane. Other suitable solvents include a ketone or an ester or a mixture thereof. Non-limiting examples of suitable ketones are methyl ethyl ketone (MEK), methyl n-propyl ketone (MPK), methyl isopropyl ketone (MIPK), methyl n-butyl ketone (MBK), methyl isobutyl ketone (MIBK), methyl n-amyl ketone (MAK), methyl isoamyl ketone (MIAK), diisobutyl ketone (DIBK), C11 ketone. Non-limiting examples of suitable esters are ethyl acetate, propyl acetate, butyl acetate, isobutyl acetate, t-butyl acetate, propyl propionate, butyl propionate, isobutyl isobutyrate, 2-ethoxy ethyl acetate, propylene glycol monomethyl ether acetate.

Water-based Polyester-(Meth)acrylate Hybrid Polymer

In another alternative embodiment, the polyester macromer-(meth)acrylate hybrid polymer contemplated in this application is a water-based polyester macromer-(meth)acrylate hybrid polymer comprising aqueous-based dispersions containing particles of the polyester macromer-(meth)acrylate hybrid polymer, as described above, dispersed throughout an aqueous-based continuous phase. In such embodiments, the polyester-(meth)acrylate hybrid polymer composition is prepared by the reaction of, or copolymerization of, or derived from, the polyester macromer and at least one ethylenically unsaturated monomer, wherein the reaction is a free radical polymerization reaction. The at least one ethylenically unsaturated monomer being selected from the group consisting of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, and vinyl monomers, and combinations thereof.

Suitable ethylenically unsaturated monomers included, but are not limited to acrylic acid, methacrylic acid, crotonic acid, crotonate esters, itaconic acid, itaconate esters, fumaric acid, fumarate esters, maleic acid, maleate esters, maleic anhydride, hydroxyl alkyl (meth)acrylate, hydroxyethyl (meth)acrylate, hydroxypropyl (meth)acrylate, hydroxybutyl (meth)acrylate, glycidyl (meth)acrylate, (meth)acrylic anhydride, isobornyl (meth)acrylate, aminoethyl methacrylate, N,N-dimethyl aminoethyl methacrylate, urea/ureido methacrylate, acrylonitrile, methacrylonitrile, acrylamide, methacrylamide, N,N-dimethylacrylamide, methyl acrylate, methyl methacrylate, ethyl acrylate, ethyl methacrylate, butyl acrylate, butyl methacrylate, propyl acrylate, propyl methacrylate, 2-ethylhexyl acrylate, 2-ethylhexyl methacrylate, lauryl acrylate, lauryl methacrylate, iso-octyl acrylate, iso-octyl methacrylate, iso-decyl acrylate, iso-decyl methacrylate, stearyl acrylate, stearyl methacrylate, vinyl propionate, styrene, alkyl-substituted styrenes, vinyl acetate, vinyl chloride, N-vinyl pyrrolidone, and combinations thereof.

The size of the particles of the water dispersible composition described above can vary. In some embodiments, the water-based polyester-(meth)acrylate hybrid polymer is as described above and has an average particle size diameter in the range of about 50 nm to about 600 nm, including all intermittent values and ranges therein, or in the alternative, from about 200 nm to about 400 nm, including all intermittent values and ranges therein, as measured by Dynamic Light Scattering.

### III. Pressure Sensitive Adhesive Compositions

According to the definition of the Pressure-Sensitive Tape Council (PSTC Test Methods for Pressure Sensitive Adhesive Tapes, Pressure Sensitive Tape Council, 15th Edition, Glossary-3, 2007), a pressure-sensitive adhesive is typically permanently tacky in dry form and can firmly adhere to a substrate with very light pressure. The adhesive requires no activation by solvent, water, or heat to exert sufficient cohesive holding power.

A widely acceptable quantitative description of a pressure sensitive adhesive (PSA) is given by the Dahlquist criterion, which indicates that materials having an elastic modulus (G′) of less than 3×10⁶ dynes/cm² (i.e., 3×10⁵ Pa) on a 1-s time scale at the test temperature have PSA properties while materials having a G′ in excess of this value do not. Empirically, it was found that materials that exhibit pressure sensitivity are those that are sufficiently soft, exhibiting an elastic modulus of less than 3×10⁵ Pa (3×10⁶ dyne/cm²) on a 1-s time scale at the test temperature. This somewhat surprising but well accepted empirical criterion was first established by Dahlquist and is commonly referred as the “Dahlquist criterion”. Stated differently, according to what has come to be known as the Dahlquist criteria, to perform as a pressure sensitive adhesive, the formulation must have a plateau shear modulus at 25° C. and 1 radian per second that is between 5×10⁴ dynes/cm² (i.e., 5×10³ Pa) and 6×10⁶ dynes/cm² (i.e., 6×10⁵ Pa) as determined by dynamic mechanical analysis. A material having plateau shear modulus greater than 1×10⁷ dynes/cm² (i.e., 1×10⁶ Pa) at 25° C. will be too stiff to exhibit tack at room temperature to be useful as pressure sensitive adhesive. A material with plateau shear modulus less than 1×10⁴ dynes/cm² (i.e., 1×10³ Pa) at 25° C. will lack sufficient cohesive strength to be useful as pressure sensitive adhesive.

The water-based and solvent-based polyester-(meth)acrylate hybrid polymers described in this application can be used in a variety of applications.

In some embodiments, the water-based and solvent-based polyester-(meth)acrylate hybrid polymers described herein are used as, or in, pressure sensitive adhesives. To ensure that the polyester-(meth)acrylate hybrid polymers exhibit pressure sensitive adhesive properties, the chemical composition of the polyester-(meth)acrylate hybrid polymers are chosen so that the final overall composition conforms to the rules of Dahlquist criteria described above and glass transition temperature requirements for pressure sensitive materials, which are known in this field of art.

The polyester-(meth)acrylate hybrid polymers described herein can be crosslinked to form pressure sensitive adhesives which exhibit a plateau shear modulus at 25° C. and 1 radian per second that is between 5×10⁴ and 6×10⁶ dynes/cm² as determined by dynamic mechanical analysis (DMA). This can be achieved via covalent crosslinking using heat, actinic or electron beam radiation, or metal based ionic crosslinking between functional groups. Table 1 below lists the types of crosslinkers for the various functional groups of the segmented polymer. Suitable additional crosslinking agents include, but are not limited to those selected from polyisocyanates, urea resins, melamine resins, urea/formaldehyde resins, melamine/formaldehyde resins, polyepoxides, polyaziridines, polycarbodiimides, metal salts such as zirconium ammonium carbonate, polyalkoxysilanes, and combinations thereof.

TABLE 1
Possible Crosslinkers for Polymers

| Functional Group | |
|---|---|
| of Polymer | Crosslinker |
| Silane | Self-reactive |
| Hydroxyl | Isocyanate, Melamine Formaldehyde, Dianhydride, |
| Carboxylic acid | Epoxy, Carboiimides, Metal Chelates, and Oxazolines |
| Epoxy | Amine, Carboxylic acid, Phosphoric acid, Mercaptan |
| Mercapto | Isocyanate, Melamine formaldehyde, Anhydride, |
| | Epoxy |
| Acetoacetate | Acrylate, Amine, Isocyanates, Metal Chelates |

In some embodiments, the pressure sensitive adhesives described herein are compostable.

In some embodiments, the pressure sensitive adhesive is as described above and exhibits a glass transition temperature (Tg) within a range of from about −100° C. to about 150° C., including all intermittent values and ranges therein, or in the alternative, from about −70° C. to about 30° C., including all intermittent values and ranges therein, or in the alternative, from about −50° C. to about 0° C., including all intermittent values and ranges therein, or in the alternative, from about −40° C. to about −10° C., including all intermittent values and ranges therein measured by differential scanning calorimetry (DSC).

In some embodiments, the pressure sensitive adhesive is as described above and the weight average molecular weight (Mw) of the pressure sensitive adhesive is within a range of from about 5,000 to about 1,000,000 g/mol, including all intermittent values and ranges therein, or in the alternative, from about 50,000 to about 750,000 g/mol, including all intermittent values and ranges therein, or in the alternative, from about 100,000 to about 500,000 g/mol, including all intermittent values and ranges therein, as determined by gel permeation chromatography (GPC).

### IV. Methods of Making Polyester-(Meth)acrylate Hybrid Polymer Compositions

A. Polyester Macromer

The present subject matter provides a method for producing a polyester macromer usable for making the water-dispersible compositions described above are also described herein. In some embodiments, the method for producing the polyester macromer includes or consists of the steps of copolymerizing (1) a monomer mixture containing one or more ethylenically unsaturated monomers, one or more epoxides, and one or more anhydrides; (2) an epoxy catalyst; and optionally (3) a free radical inhibitor to form a terminally ethylenically unsaturated polyester macromer copolymer. Details describing the one or more ethylenically unsaturated monomers, one or more epoxides, and the one or more anhydrides are as previously described under the subtitle “A. Polyester Portion (Polyester Macromer or Oligomer)”.

In some embodiments, the copolymerizing includes the step of initiating with an ethylenically unsaturated monomer containing an acid or an alcohol-functional group or terminating with an ethylenically unsaturated monomer.

In other embodiments, the copolymerizing includes the step of initiating with a tertiary amine-containing protic compound or a tertiary phosphine-containing protic compound.

In still other embodiments, the copolymerizing includes the step of initiating with a quaternary ammonium-containing protic compound or a quaternary phosphonium containing protic compound.

In some embodiments, the copolymerizing includes the step of initiating with a non-ethylenically unsaturated alcohol and the polymerization of the polyester macromer is terminated with the one or more ethylenically unsaturated monomers. Suitable non-ethylenically unsaturated alcohols include, but are not limited to linear or branched aliphatic alcohols having C1 to C22 carbon atoms, cyclic aliphatic (alicyclic) alcohols having at least three carbon rings, cyclic aliphatic (alicyclic) alcohols having one or more aliphatic side chains attached, aromatic alcohols, mono-phenolic compounds, aliphatic or aromatic substituted phenol groups, and combinations thereof.

In other embodiments, the copolymerizing includes the step of initiating with a non-ethylenically unsaturated carboxylic acid and the polymerization of the polyester macromer is terminated with the one or more ethylenically unsaturated monomers. Suitable non-ethylenically unsaturated carboxylic acids include, but are not limited to linear or branched aliphatic carboxylic acids having C1 to C22 carbon atoms, cyclic aliphatic (alicyclic) carboxylic acids having at least three carbon rings, aromatic acid, cyclic aliphatic (alicyclic) carboxylic acids having one or more aliphatic side chains attached, aliphatic or aromatic substituted aromatic acids, polycyclic acids, and combinations thereof.

In still other embodiments, the copolymerizing includes the step of initiating with a non-ethylenically unsaturated secondary amine and the polymerization of the polyester macromer is terminated with the one or more ethylenically unsaturated monomers. Suitable non-ethylenically unsaturated secondary amines include, but are not limited to linear or branched aliphatic secondary amines having C1 to C22 carbon atoms, cyclic aliphatic (alicyclic) secondary amines having at least three carbon rings, cyclic aliphatic (alicyclic) secondary amines having one or more aliphatic side chains attached, aromatic secondary amines, aliphatic or aromatic substituted aromatic secondary amines, and combinations thereof.

In some embodiments, the method for producing the polyester macromer is as described above and the epoxy catalyst initiates the polymerization of the polyester macromer and catalyzes the reaction between the one or more epoxides and the one or more anhydrides. In such embodiments wherein the epoxy catalyst serves the dual functions of both initiating the polymerization and catalyzing the reaction between the epoxides and the anhydrides, the reaction would not require the addition of another or separate catalyst. Suitable dual function epoxy catalysts include, but are not limited to tertiary amine-containing protic compounds (such as N,N-dimethylethanol amine) and quaternary ammonium-containing protic compounds (such as choline chloride). Importantly, such embodiments advantageously would not require an additional process to extract a compound or catalyst that would be undesirable in applications such as food contact applications.

Suitable epoxy catalysts include, but are not limited to tertiary amines, tertiary phosphines, quaternary ammonium salts, quaternary phosphonium salts, imidazoles, dicyandiamide, lewis acids (boron trifluoride complexes), UV super acid complexes, organic acid hydrazides, alkali metal carboxylates, and combinations thereof.

In other embodiments, the method for producing the polyester macromer is as described above and the polyester macromer is optionally further reacted with a cyclic ester to incorporate the ring opened cyclic ester into the polyester macromer. Suitable cyclic esters include, but are not limited to glycolide, lactide, α-acetolactone, β-propiolactone, γ-butyrolactone, δ-valerolactone, E-caprolactone, and combinations thereof. Alcohol groups are generated during the copolymerization process to form the polyester macromer. The ester rings of the cyclic esters may transterify with these alcohol groups. The alcohol ring opens the cyclic ester to generate another alcohol which could react with an anhydride. It's a transesterification process where an alcohol-ester interchange occurs resulting in the ring opened cyclic ester being incorporated into the backbone of the polyester macromer to create a more structurally diverse polyester macromer.

In some embodiments, the method for producing the polyester macromer is as described above and further comprises converting residual hydroxyl groups to esters after completion of the polymerization.

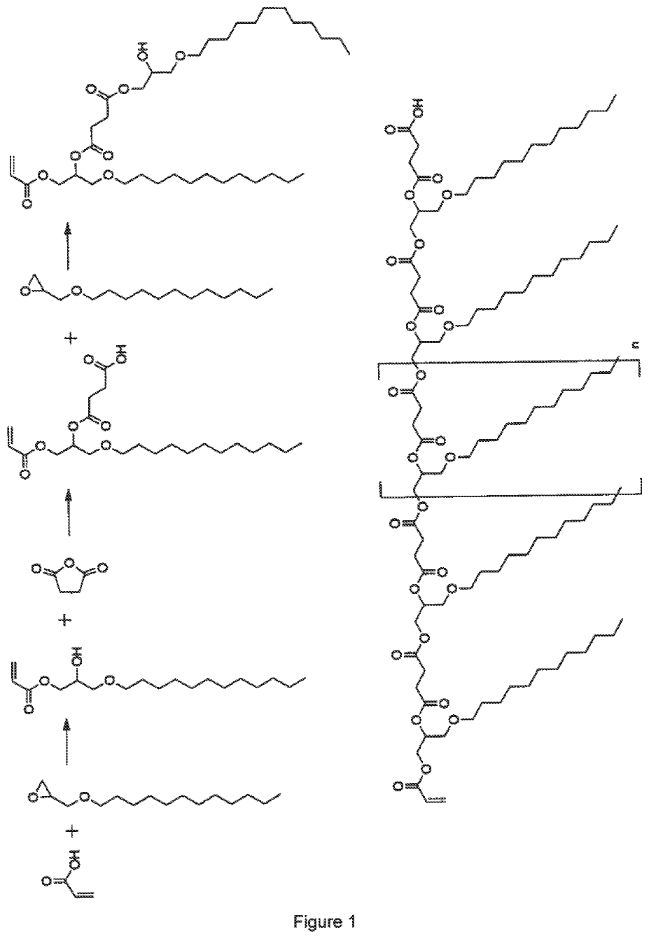

In some embodiments, a representative example of the structure of the polyester macromer is shown in FIG. 1. The polyester macromer produced in the above described methods comprises or consists of an alternating copolymer containing or consisting of up to 50 repeating (AB) or (BA) units or a combination thereof, wherein (A) is an epoxide and (B) is an anhydride (B). FIG. 1 depicts a polyester macromer formed by initiating the macromer polymerization with an ethylenically unsaturated monomer containing an acid (e.g. acrylic acid). Note, the polymerization of the polyester macromer contemplated in this application is initiated with an ethylenically unsaturated monomer containing an acid or an alcohol-functional group or terminated with an ethylenically unsaturated monomer. However, if the polymerization of the macromer is initiated using a monomer containing an alcohol group, the alcohol group will first react with the anhydride which would result in a polyester macromer containing an alternating copolymer containing or consisting of repeating (BA) units or a combination thereof, wherein (B) is an anhydride (B) and (A) is an epoxide. It is the initiator that determines what reacts with it first. That is, if the initiator is an acid, it will react with the epoxide first and if the initiator is an alcohol, it will react with the anhydride first.

In some embodiments, the polyester macromer produced in the above described methods is monounsaturated.

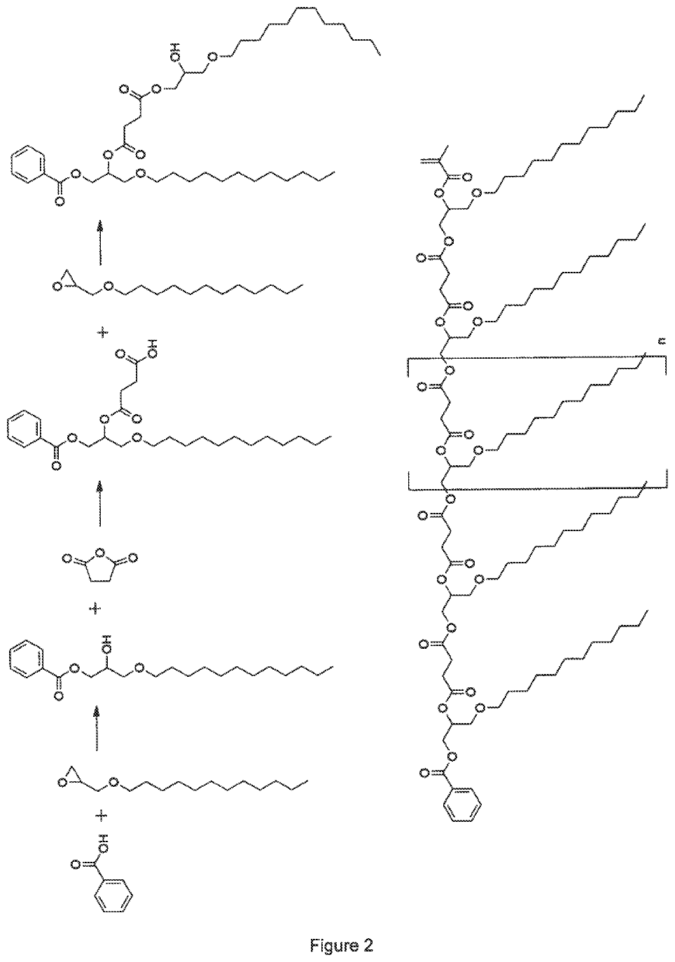

In some embodiments, the polyester macromer produced in the above described methods contains only one terminal ethylenically unsaturated group as shown in FIGS. 1 and 2.

In alternative embodiments, a representative example of the structure of the polyester macromer is shown in FIG. 2. FIG. 1 depicts a polyester macromer formed by initiating the macromer polymerization with a non-ethylenically unsaturated monomer containing an acid (e.g., benzoic acid). In such embodiments, the macromer polymerization is terminated with an ethylenically unsaturated monomer.

In some embodiments, the method for producing the polyester macromer is as described above and the polyester macromer is solvent free.

In some embodiments, the method for producing the polyester macromer is as described above and the method is solvent free.

Based on the different possible combinations of the monomer mixtures (i.e., the disclosed ethylenically unsaturated monomers, the epoxides, and the anhydrides), the polyester macromers described herein may contain one or more different macromers. The polyester macromer can contain or consist of a single macromer or a mixture of macromers. In some embodiments, the macromers in the mixture have the same chemical composition but different molecular weights, different chemical compositions but the same or similar molecular weights, different chemical compositions and different molecular weights, and combinations thereof.

The molecular weight of the polyester macromer can vary based on the desired properties of the polyester macromer, the polyester-(meth)acrylate hybrid polymer, or compositions containing the same. In some embodiments, the method for producing the polyester macromer is as described above and the weight average molecular weight (Mw) of the polyester macromer is within a range of from about 300 g/mol to about 20,000 g/mol, including all intermittent values and ranges therein, or in the alternative, from about 300 g/mol to about 10,000 g/mol, including all intermittent values and ranges therein, or in the alternative, from about 300 g/mol to about 5,000 g/mol, including all intermittent values and ranges therein, or in the alternative, from about 500 g/mol to about 10,000 g/mol, including all intermittent values and ranges therein, or in the alternative, from about 1000 g/mol to about 6,000 g/mol, including all intermittent values and ranges therein, as determined by gel permeation chromatography (GPC).

In some embodiments, the method for producing the polyester macromer is as described above and the polyester macromer exhibits a glass transition temperature (Tg) within a range of from about −100° C. to about 150° C., including all intermittent values and ranges therein, or in the alternative, from about −50° C. to about 100° C., including all intermittent values and ranges therein, or in the alternative, from about −30° C. to about 50° C., including all intermittent values and ranges therein, measured by differential scanning calorimetry (DSC).

B. Water Dispersible Compositions

The present subject matter provides a method for producing water-dispersible compositions containing or consisting of polyester-(meth)acrylate hybrid polymer particles.

In some embodiments, the method for producing the water-dispersed compositions include the steps of (1) providing the polyester macromer prepared by the methods for producing the polyester macromer described above;

(2) dissolving the polyester macromer in a monomer mixture to form a polymer-in-monomer solution, wherein the monomer mixture contains one or more ethylenically unsaturated monomers;

(3) combining the polymer-in-monomer solution with at least one surfactant, water, a neutralizing agent, and optionally one or more co-stabilizer to form a pre-emulsion;

(4) agitating the pre-emulsion under high shear to form a mini-emulsion, the mini-emulsion comprising an aqueous continuous phase and an organic disperse phase, the disperse phase being in the form of droplets having an average droplet diameter in the range of from about 50 to about 600 nanometers measured by Dynamic Light Scattering; and

(5) subjecting the mini-emulsion to free radical polymerization thereby copolymerizing the monomer mixture and the polyester macromer to form a polymer emulsion in which the polymer content is in the form of particles comprising an average particle diameter in the range of from about 50 to about 600 nanometers measured by Dynamic Light Scattering, wherein the particles comprise the polyester macromer covalently bound to a (meth)acrylate polymer formed from copolymerizing the monomer mixture to produce a polyester-(meth)acrylate hybrid polymer. The polyester macromer is present in the polyester-(meth)acrylate hybrid polymer at level of about 5% to about 95% by weight, based on the total weight of the polyester-(meth)acrylate hybrid polymer, including all intermittent values and ranges therein, e.g., from about 10% to about 95%, from about 15% to about 95%, from about 20% to about 95%, from about 25% to about 95%, from about 30% to about 95%, from about 35% to about 95%, from about 40% to about 95%, from about 45% to about 95%, from about 50% to about 95%, from about 55% to about 95%, from about 60% to about 95%, from about 65% to about 95%, from about 70% to about 95%, from about 75% to about 95%, from about 80% to about 95%, from about 85% to about 95%, and from about 90% to about 95% of the polyester-(meth)acrylate hybrid polymer.

For particles that are not spherical, the diameter of the particle is the average of the long and short axes of the particle. Particle sizes may be measured on a Beckman-Coulter LS230 laser-diffraction particle size analyzer or other suitable devices.

In certain embodiments, the method for producing water-dispersible compositions containing polyester-(meth)acrylate hybrid polymer particles is as described above and in step (2) the monomer mixture optionally comprises one or more tackifiers and/or the mini-emulsion inn step (4) optionally comprises one or more tackifiers post added to the mini-emulsion as a pre-dispersion. In such embodiments, the tackifier in the monomer mixture is chemically the same or different from the tackifier that is post added to the mini-emulsion.

In some embodiments, the method for producing water-dispersible compositions containing polyester-(meth)acrylate hybrid polymer particles is as described above and the polymer-in-monomer solution in step (2) further contains an additional agent that is admixed therein, wherein the additional agent is or contains a photoinitiator moiety. The additional agent may contain the photoinitiator moiety at the time it is admixed or covalently bound to the polymer (e.g., during polymerization or post polymerization) or the photoinitiator moiety can be generated in-situ. Suitable photoinitiators include, but are not limited to, acetophenone or derivatives thereof, benzophenone or derivatives thereof, anthraquinone or derivatives thereof, benzile or derivatives thereof, thioxanthone or derivatives thereof, xanthone or derivatives thereof, a benzoin ether or derivatives thereof, an alpha-ketol or derivatives thereof, and combinations thereof.

In embodiments whereby a monomer containing a photoinitiator moiety is added into the polymer-in-monomer solution, the polymerization of the mini-emulsion generates a (meth)acrylate copolymer containing a photoinitiator moiety in the form of a distinct agent that is added to the composition, or a photoinitiator moiety bound to the (meth)acrylate copolymer backbone, or a photoinitiator moiety formed in-situ by an association of materials or agents in the composition.

In some embodiments, the method for producing water-dispersible compositions containing polyester-(meth)acrylate hybrid polymer particles is as described above and the photoinitiator is activatable upon exposure to UV radiation to at least partially polymerize and/or crosslink the composition.

In some embodiments, the method for producing water-dispersible compositions containing polyester-(meth)acrylate hybrid polymer particles is as described above and in step (2) the one or more ethylenically unsaturated monomers is selected from the group consisting of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, vinyl monomers, and combinations thereof. Suitable ethylenically unsaturated monomers include, but are not limited to acrylic acid, methacrylic acid, crotonic acid, crotonate esters, itaconic acid, itaconate esters, fumaric acid, fumarate esters, maleic acid, maleate esters, maleic anhydride, hydroxyl alkyl (meth)acrylate, hydroxyethyl (meth)acrylate, hydroxypropyl (meth)acrylate, glycidyl (meth)acrylate, (meth)acrylic anhydride, isobornyl (meth)acrylate, aminoethyl methacrylate, N,N-dimethyl aminoethyl methacrylate, urea/ureido methacrylate, acrylonitrile, methacrylonitrile, acrylamide, methacrylamide, N,N-dimethylacrylamide, methyl acrylate, methyl methacrylate, ethyl acrylate, ethyl methacrylate, butyl acrylate, butyl methacrylate, propyl acrylate, propyl methacrylate, 2-ethylhexyl acrylate, 2-ethylhexyl methacrylate, lauryl acrylate, lauryl methacrylate, iso-octyl acrylate, iso-octyl methacrylate, iso-decyl acrylate, iso-decyl methacrylate, stearyl acrylate, stearyl methacrylate, vinyl propionate, styrene, alkyl-substituted styrenes, vinyl acetate, vinyl chloride, N-vinyl pyrrolidone, and combinations thereof.

1. Mini-Emulsion

The use of the noted mini-emulsion allows the preparation of stable nano-sized droplets of monomer in aqueous dispersion. These nano-sized monomer droplets are efficiently converted to polymer particles via the use of thermal initiators. The thermal initiator may be dissolved within the monomer mixture prior to forming the mini-emulsion or it may be added as an aqueous solution to the aqueous phase. Using the appropriate concentration of initiator, the nano-sized monomer droplets are converted to nano-sized polymer particles as they begin to polymerize from the outset. The overwhelmingly large polymer particle surface area provided by the nano-sized polymer particles of the present subject matter effectively absorb monomer from the water phase when it comes to time to replenish the monomer. This means that initial monomer droplets are needed which have diameters less than about 500 nm and in certain embodiments, less than 300 nm. Although diameters less than about 500 nm are used in many embodiments of the present subject matter, it is contemplated that in certain applications, larger particles could be used such as up to about 600 nm. When stable nano-sized monomer droplets are achieved, they can be readily converted to stable nano-sized polymer droplets by activating the thermal initiator to cause the polymerization reaction to occur. Ideally, all the monomer droplets are transformed to polymer particles. Once polymer particles are formed, standard emulsion polymerization processes can be used, provided radical flux is maintained at low enough levels to ensure the free-radical polymerization. Controlling the size and number of polymer particles at the beginning of reactions is beneficial for a number of reasons. One reason is that the batch to batch variation is reduced as compared to conventional emulsion polymerization.

A difference between standard monomer emulsion and a mini-emulsion process is the use of high energy mixing, i.e., high shear mixing and one or more co-stabilizer(s) to create mini-emulsion nano-dispersions. High shear mixing provides the means to violently rip micron-sized monomer droplets apart. The micron-sized droplets can be reduced to nano-sized droplets using high shear mixing. However, without co-stabilizer added to the monomer phase, those monomer nano-droplets quickly “Ostwald ripen” back to micron sized particles. Ostwald ripening is a process in which monomer diffuses from nano-sized droplets to micron sized and larger droplets. It is a thermodynamically driven process. There is a high energy cost in maintaining small droplets, where there is very large surface area to volume ratios. It is energetically favorable for the sparingly soluble monomers to exist as much larger particles.

The mini-emulsion co-stabilizer is an extremely water-insoluble material. Co-stabilizers are hydrophobic and are soluble in hydrophobic acrylic monomers. Within academia, co-stabilizers are usually hexadecane or other small molecule, water insoluble solvents. They are used at levels of around 5% by weight based on monomer. In the mini-emulsions described herein, the hydrophobic nature of the polyester macromer acts as a co-stabilizer. They typically function as follows.

Osmotic pressure is a force relied upon by the present subject matter methods. Due to its very low water solubility, the co-stabilizer is compelled to remain inside the droplet. Ostwald ripening drives changes in droplet size but monomer diffusion out of the droplet will lead to higher co-stabilizer concentration inside the droplet. It is osmotic pressure that acts to prevent monomer from diffusing out of the particle and thereby driving the co-stabilizer concentration within droplets higher. The nano-dispersions thus formed are kinetically stable and their nano-size can remain unchanged for weeks.

The present subject matter methods utilize one or more polyester macromers as copolymerizable co-stabilizer(s). The hydrophobic nature of the polyester macromer acts as a co-stabilizer. It will be understood that the present subject matter includes the use of other co-stabilizers. A nonlimiting example of such a stabilizer is heptadecyl acrylate, an acrylate with 17 carbons that is a sufficiently small molecule and is highly water insoluble. The small size contributes to its required mobility as a co-stabilizer. This co-stabilizer is a reactive acrylate with a low glass transition temperature (Tg). As a reactive acrylate, heptadecyl acrylate readily copolymerizes with the monomers employed and its low glass transition temperature and hydrophobic nature makes it a useful component monomer for constructing polymers used in pressure sensitive adhesives (PSAs). This co-stabilizer is also liquid at ambient temperature which makes it easy to handle at production scale.

In some embodiments, the method for producing water-dispersible compositions containing polyester-(meth)acrylate hybrid polymer particles is as described above and the weight ratio of the polyester macromer to the (meth)acrylate copolymer is within the range of from about 5:95 to about 95:5 of the polyester-(meth)acrylate hybrid polymer, including all intermittent values and ranges therein, e.g., from about 10:90 to about 95:5, from about 15:85 to about 95:5, from about 20:80 to about 95:5%, from about 25:75 to about 95:5, from about 30:70 to about 95:5%, from about 35:65 to about 95:5, from about 40:60 to about 95:5%, from about 45:55 to about 95:5, from about 50:50 to about 95:5%, from about 55:45 to about 95:5, from about 60:40 to about 95:5%, from about 65:35 to about 95:5%, from about 70:30 to about 95:5%, from about 75:25 to about 95:5, from about 80:20 to about 95:5%, from about 85:15 to about 95:5, and from about 90:10 to about 95:5% of the polyester-(meth)acrylate hybrid polymer.

In other embodiments, the method for producing water-dispersible compositions containing polyester-(meth)acrylate hybrid polymer particles is as described above and the polyester macromer contains or consists of a majority proportion of the polyester-(meth)acrylate hybrid polymer.

In yet other embodiments, the method for producing water-dispersible compositions containing polyester-(meth)acrylate hybrid polymer particles is as described above and the weight ratio of the polyester macromer to the (meth)acrylate copolymer is within the range of from about 50:50 to about 95:5 of the polyester-(meth)acrylate hybrid polymer.

In still other embodiments, the method for producing water-dispersible compositions containing polyester-(meth)acrylate hybrid polymer particles is as described above and the weight ratio of the polyester macromer to the (meth)acrylate copolymer is within the range of from about 70:30 to about 95:5 of the polyester-(meth)acrylate hybrid polymer. During the polymerization step to form the aqueous-based dispersions of the polyester-(meth)acrylate hybrid polymer particles, the large concentration of the polyester macromer reduces the formation and concentration of long acrylic polymer chains (which are not compostable).

In some embodiments, the method for producing water-dispersible compositions containing polyester-(meth)acrylate hybrid polymer particles is as described above and the average particle size diameter is in the range of about 50 nm to about 600 nm, including all intermittent values and ranges therein, or in the alternative, from about 200 nm to about 500 nm, including all intermittent values and ranges therein, as measured by Dynamic Light Scattering.

In some embodiments, the method for producing water-dispersible compositions containing polyester-(meth)acrylate hybrid polymer particles is as described above and the composition further comprises additives selected from the group consisting of pigments, fillers, plasticizers, diluents, antioxidants, waxes, tackifiers, crosslinkers, and combinations thereof.

In still some embodiments, the method for producing water-dispersible compositions containing polyester-(meth)acrylate hybrid polymer particles is as described above and the polyester-(meth)acrylate hybrid polymer exhibits a single glass transition temperature (Tg) within a range of from about −100° C. to about 150° C., including all intermittent values and ranges therein, or in the alternative, from about −70° C. to about 30° C., including all intermittent values and ranges therein, or in the alternative, from about −50° C. to about 0° C., including all intermittent values and ranges therein, or in the alternative, from about −40° C. to about −10° C., including all intermittent values and ranges therein measured by differential scanning calorimetry (DSC).

In alternative embodiments, the method for producing water-dispersible compositions containing polyester-(meth)acrylate hybrid polymer particles is as described above and the polyester macromer and the (meth)acrylate polymer are phase separated. In such embodiments, the polyester-(meth)acrylate hybrid polymer exhibits at least two glass transition temperatures (Tg) within a range of from about −100° C. to about 150° C. measured by differential scanning calorimetry (DSC), wherein the glass transition temperature (Tg) of the polyester macromer is within a range of from about 0° C. to about 150° C., including all intermittent values and ranges therein, or in the alternative, or from about 25° C. to about 130° C., including all intermittent values and ranges therein, or in the alternative, from about 50° C. to about 110° C., including all intermittent values and ranges therein, and the glass transition temperature (Tg) of the (meth)acrylate polymer is within a range of from about −100° C. to about 150° C., including all intermittent values and ranges therein, or in the alternative, from about −70° C. to about 30° C., including all intermittent values and ranges therein, or in the alternative, from about −50° C. to about 0° C., including all intermittent values and ranges therein, or in the alternative, from about −40° C. to about −10° C., including all intermittent values and ranges therein measured by differential scanning calorimetry (DSC).

In yet some embodiments, the method for producing water-dispersible compositions containing polyester-(meth)acrylate hybrid polymer particles is as described above and the weight average molecular weight (Mw) of the polyester-(meth)acrylate hybrid polymer is within a range of from about 5000 g/mol to about 1,000,000 g/mol, including all intermittent values and ranges therein, or in the alternative, from about 50,000 to about 750,000 g/mol, including all intermittent values and ranges therein, or in the alternative, from about 100,000 to about 500,000 g/mol, including all intermittent values and ranges therein, as determined by gel permeation chromatography (GPC).

In some embodiments, the method for producing water-dispersible compositions containing polyester-(meth)acrylate hybrid polymer particles is as described above and the method further comprises the step of crosslinking the polyester-(meth)acrylate hybrid polymer to form a pressure sensitive adhesive, wherein the pressure sensitive adhesive exhibits a plateau shear modulus at 25° C. and 1 radian per second that is between 5×10⁴ and 6×10⁶ dynes/cm² as determined by dynamic mechanical analysis (DMA).

In yet some embodiments, the method for producing water-dispersible compositions containing polyester-(meth)acrylate hybrid polymer particles is as described above and the weight average molecular weight (Mw) of the pressure sensitive adhesive is within a range of from about 5000 g/mol to about 1,000,000 g/mol, including all intermittent values and ranges therein, or in the alternative, from about 50,000 to about 750,000 g/mol, including all intermittent values and ranges therein, or in the alternative, from about 100,000 to about 500,000 g/mol, including all intermittent values and ranges therein, as determined by gel permeation chromatography (GPC).

C. Solvent-Based Polyester-(Meth)acrylate Hybrid Polymer

The present subject matter provides a method for producing a solvent-based polyester-(meth)acrylate hybrid polymer. The method comprises or consists of the steps of,

(1) providing a (meth)acrylate polymer optionally dissolved in an aprotic solvent, the (meth)acrylate polymer containing an acid and/or an alcohol functional group on the polymer backbone;

(2) copolymerizing the (meth)acrylate polymer with one or more epoxides, one or more anhydrides, an epoxy catalyst, and optionally a free radical inhibitor to form the polyester-(meth)acrylate hybrid polymer, wherein the step of copolymerizing comprises growing a side chain polyester oligomer off of the (meth)acrylate polymer.

Suitable epoxy catalysts include, but are not limited to tertiary amines, tertiary phosphines, quaternary ammonium salts, quaternary phosphonium salts, imidazoles, dicyandiamide, lewis acids (boron trifluoride complexes), UV super acid complexes, organic acid hydrazides, alkali metal carboxylates, and combinations thereof. Preferably, the aprotic solvent is aromatic solvent selected from one or more of toluene, xylene and naphthalene or an aliphatic hydrocarbon solvent selected from hexane, heptane, octane, nonane, decane. Other suitable solvents include a ketone or an ester or a mixture thereof. Non-limiting examples of suitable ketones are methyl ethyl ketone (MEK), methyl n-propyl ketone (MPK), methyl isopropyl ketone (MIPK), methyl n-butyl ketone (MBK), methyl isobutyl ketone (MIBK), methyl n-amyl ketone (MAK), methyl isoamyl ketone (MIAK), diisobutyl ketone (DIBK), C11 ketone. Non-limiting examples of suitable esters are ethyl acetate, propyl acetate, butyl acetate, isobutyl acetate, t-butyl acetate, propyl propionate, butyl propionate, isobutyl isobutyrate, 2-ethoxy ethyl acetate, propylene glycol monomethyl ether acetate.

In some embodiments, the method for producing a solvent-based polyester-(meth)acrylate hybrid polymer is as described above and the polyester oligomer is present in the polyester-(meth)acrylate hybrid polymer at level of about 5% to about 95% by weight, based on the total weight of the polyester-(meth)acrylate hybrid polymer, including all intermittent values and ranges therein, e.g., from about 10% to about 95%, from about 15% to about 95%, from about 20% to about 95%, from about 25% to about 95%, from about 30% to about 95%, from about 35% to about 95%, from about 40% to about 95%, from about 45% to about 95%, from about 50% to about 95%, from about 55% to about 95%, from about 60% to about 95%, from about 65% to about 95%, from about 70% to about 95%, from about 75% to about 95%, from about 80% to about 95%, from about 85% to about 95%, and from about 90% to about 95% of the polyester-(meth)acrylate hybrid polymer.

In some embodiments, the method for producing the solvent-based polyester-(meth)acrylate hybrid polymer compositions is as described above and the composition optionally comprises one or more tackifiers.

In some embodiments, the method for producing the solvent-based polyester-(meth)acrylate hybrid polymer compositions is as described above and the (meth)acrylate polymer is prepared by copolymerizing at least one of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, and vinyl monomers, optionally dissolved in an aprotic solvent.

Suitable monomers useful for the preparation of the (meth)acrylate polymer include, but are not limited to acrylic acid, methacrylic acid, crotonic acid, crotonate esters, itaconic acid, itaconate esters, fumaric acid, fumarate esters, maleic acid, maleate esters, maleic anhydride, hydroxyl alkyl (meth)acrylate, hydroxyethyl (meth)acrylate, hydroxypropyl (meth)acrylate, hydroxybutyl (meth)acrylate, glycidyl (meth)acrylate, (meth)acrylic anhydride, isobornyl (meth)acrylate, aminoethyl methacrylate, N,N-dimethyl aminoethyl methacrylate, urea/ureido methacrylate, acrylonitrile, methacrylonitrile, acrylamide, methacrylamide, N,N-dimethylacrylamide, methyl acrylate, methyl methacrylate, ethyl acrylate, ethyl methacrylate, butyl acrylate, butyl methacrylate, propyl acrylate, propyl methacrylate, 2-ethylhexyl acrylate, 2-ethylhexyl methacrylate, lauryl acrylate, lauryl methacrylate, iso-octyl acrylate, iso-octyl methacrylate, iso-decyl acrylate, iso-decyl methacrylate, stearyl acrylate, stearyl methacrylate, vinyl propionate, styrene, alkyl-substituted styrenes, vinyl acetate, vinyl chloride, and N-vinyl pyrrolidone, optionally dissolved in an aprotic solvent.

In some embodiments, the method for producing the solvent-based polyester-(meth)acrylate hybrid polymer compositions is as described above and the (meth)acrylate hybrid polymer contains a photoinitiator moiety in the form of a distinct agent that is added to the composition, or a photoinitiator moiety bound to the polymer backbone, or a photoinitiator moiety formed in-situ by an association of materials or agents in the composition. In some embodiments, the photoinitiator moiety is bound to the (meth)acrylate polymer. Suitable photoinitiators include, but are not limited to acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof.

In other embodiments, the method for producing the solvent-based polyester-(meth)acrylate hybrid polymer compositions is as described above and the photoinitiator is activatable upon exposure to UV radiation to at least partially polymerize and/or crosslink the polyester-(meth)acrylate hybrid polymer.

In some embodiments, the method for producing the solvent-based polyester-(meth)acrylate hybrid polymer compositions is as described above and the weight ratio of the polyester oligomer to the (meth)acrylate copolymer is within the range of from about 5:95 to about 95:5 of the polyester-(meth)acrylate hybrid polymer, including all intermittent values and ranges therein, e.g., from about 10:90 to about 95:5, from about 15:85 to about 95:5, from about 20:80 to about 95:5%, from about 25:75 to about 95:5, from about 30:70 to about 95:5%, from about 35:65 to about 95:5, from about 40:60 to about 95:5%, from about 45:55 to about 95:5, from about 50:50 to about 95:5%, from about 55:45 to about 95:5, from about 60:40 to about 95:5%, from about 65:35 to about 95:5%, from about 70:30 to about 95:5%, from about 75:25 to about 95:5, from about 80:20 to about 95:5%, from about 85:15 to about 95:5, and from about 90:10 to about 95:5% of the polyester-(meth)acrylate hybrid polymer.

In other embodiments, the method for producing the solvent-based polyester-(meth)acrylate hybrid polymer compositions is as described above and the polyester oligomer contains or consists of a majority proportion of the polyester-(meth)acrylate hybrid polymer.

In yet other embodiments, the method for producing the solvent-based polyester-(meth)acrylate hybrid polymer compositions is as described above and the weight ratio of the polyester oligomer to the (meth)acrylate copolymer is within the range of from about 50:50 to about 95:5 of the polyester-(meth)acrylate hybrid polymer.

In still other embodiments, the method for producing the solvent-based polyester-(meth)acrylate hybrid polymer compositions is as described above and the weight ratio of the polyester oligomer to the (meth)acrylate copolymer is within the range of from about 70:30 to about 95:5 of the polyester-(meth)acrylate hybrid polymer.

In some embodiments, the method for producing the solvent-based polyester-(meth)acrylate hybrid polymer compositions is as described above and the polyester oligomer comprises an alternating copolymer comprising up to 50 repeating (AB) units or (BA) units or a combination thereof, wherein (A) is an epoxide and (B) is an anhydride (B).

In other embodiments, the method for producing the solvent-based polyester-(meth)acrylate hybrid polymer compositions is as described above and the polyester oligomer contains 1 to 20 repeating (AB) units or (BA) units or a combination thereof.

In still other embodiments, the method for producing the solvent-based polyester-(meth)acrylate hybrid polymer compositions is as described above and the polyester oligomer contains 1 to 10 repeating (AB) units or (BA) units or a combination thereof.

In some embodiments, the method for producing the solvent-based polyester-(meth)acrylate hybrid polymer compositions is as described above and the details describing the one or more ethylenically unsaturated monomers, one or more epoxides, and the one or more anhydrides are as previously described under the subtitle “A. Polyester Portion (Polyester Macromer or Oligomer)”.

In some embodiments, the method for producing the solvent-based polyester-(meth)acrylate hybrid polymer compositions is as described above and the epoxy catalyst is selected from the group consisting of tertiary amines, tertiary phosphines, quaternary ammonium salts, quaternary phosphonium salts, imidazoles, dicyandiamide, lewis acids (boron trifluoride complexes), UV super acid complexes, organic acid hydrazides, alkali metal carboxylates, and combinations thereof.

In other embodiments, the method for producing the solvent-based polyester-(meth)acrylate hybrid polymer compositions is as described above and the polyester oligomer is optionally further reacted with a cyclic ester to incorporate the ring opened cyclic ester into the polyester macromer. Suitable cyclic esters include, but are not limited to glycolide, lactide, α-acetolactone, β-propiolactone, γ-butyrolactone, δ-valerolactone, E-caprolactone, and combinations thereof. During the copolymerization process to form the polyester oligomer, alcohol groups are generated. The ester rings of the cyclic esters may transterify with these alcohol groups. The alcohol ring opens the cyclic ester to generate another alcohol which could react with an anhydride. It's a transesterification process where an alcohol-ester interchange occurs resulting in the ring opened cyclic ester being incorporated into the backbone of the polyester oligomer to create a more structurally diverse polyester oligomer.

In some embodiments, the method for producing the solvent-based polyester-(meth)acrylate hybrid polymer compositions is as described above and further comprises a step of converting residual hydroxyl groups to esters after completion of the polymerization.

In some embodiments, the method for producing the solvent-based polyester-(meth)acrylate hybrid polymer compositions is as described above and the composition further comprises additives selected from the group consisting of pigments, fillers, plasticizers, diluents, antioxidants, waxes, tackifiers, crosslinkers, and combinations thereof.

In some embodiments, the method for producing the solvent-based polyester-(meth)acrylate hybrid polymer compositions is as described above and the (meth)acrylate polymer exhibits a glass transition temperature (Tg) within a range of from about −100° C. to about 150° C., including all intermittent values and ranges therein, or in the alternative, from about −70° C. to about 30° C., including all intermittent values and ranges therein, or in the alternative, from about −50° C. to about 0° C., including all intermittent values and ranges therein, or in the alternative, from about −40° C. to about −10° C., including all intermittent values and ranges therein measured by differential scanning calorimetry (DSC).

In still some embodiments, the method for producing the solvent-based polyester-(meth)acrylate hybrid polymer compositions is as described above and the weight average molecular weight (Mw) of the (meth)acrylate polymer is within a range of from about 5,000 to about 1,000,000 g/mol, including all intermittent values and ranges therein, or in the alternative, from about 50,000 to about 750,000 g/mol, including all intermittent values and ranges therein, or in the alternative, from about 100,000 to about 500,000 g/mol, including all intermittent values and ranges therein, as determined by gel permeation chromatography (GPC).

In other embodiments, the method for producing the solvent-based polyester-(meth)acrylate hybrid polymer compositions is as described above and the polyester-(meth)acrylate hybrid polymer exhibits a single glass transition temperature (Tg) within a range of from about −100° C. to about 150° C., including all intermittent values and ranges therein, or in the alternative, from about −70° C. to about 30° C., including all intermittent values and ranges therein, or in the alternative, from about −50° C. to about 0° C., including all intermittent values and ranges therein, or in the alternative, from about −40° C. to about −10° C., including all intermittent values and ranges therein measured by differential scanning calorimetry (DSC).

In alternative embodiments, the method for producing the solvent-based polyester-(meth)acrylate hybrid polymer compositions is as described above and the polyester oligomer and the (meth)acrylate polymer are phase separated. In such embodiments, the polyester-(meth)acrylate hybrid polymer exhibits at least two glass transition temperatures (Tg) within a range of from about −100° C. to about 150° C. measured by differential scanning calorimetry (DSC), wherein the glass transition temperature (Tg) of the polyester oligomer is within a range of from about 0° C. to about 150° C., including all intermittent values and ranges therein, or in the alternative, or from about 25° C. to about 130° C., including all intermittent values and ranges therein, or in the alternative, from about 50° C. to about 110° C., including all intermittent values and ranges therein, and the glass transition temperature (Tg) of the (meth)acrylate polymer is within a range of from about −100° C. to about 150° C., including all intermittent values and ranges therein, or in the alternative, from about −70° C. to about 30° C., including all intermittent values and ranges therein, or in the alternative, from about −50° C. to about 0° C., including all intermittent values and ranges therein, or in the alternative, from about −40° C. to about −10° C., including all intermittent values and ranges therein measured by differential scanning calorimetry (DSC).

In yet some embodiments, the method for producing the solvent-based polyester-(meth)acrylate hybrid polymer compositions is as described above and the weight average molecular weight (Mw) of the polyester-(meth)acrylate hybrid polymer is within a range of from about 5000 g/mol to about 1,000,000 g/mol, including all intermittent values and ranges therein, or in the alternative, from about 50,000 to about 750,000 g/mol, including all intermittent values and ranges therein, or in the alternative, from about 100,000 to about 500,000 g/mol, including all intermittent values and ranges therein, as determined by gel permeation chromatography (GPC).

In some embodiments, the method for producing the solvent-based polyester-(meth)acrylate hybrid polymer compositions is as described above and the method further comprises the step of crosslinking the polyester-(meth)acrylate hybrid polymer to form a pressure sensitive adhesive, wherein the pressure sensitive adhesive exhibits a plateau shear modulus at 25° C. and 1 radian per second that is between 5×10⁴ and 6×10⁶ dynes/cm² as determined by dynamic mechanical analysis (DMA).

In other embodiments, the method for producing the solvent-based polyester-(meth)acrylate hybrid polymer compositions is as described above and the pressure sensitive adhesive and the weight average molecular weight (Mw) of the pressure sensitive adhesive is within a range of from about 5000 g/mol to about 1,000,000 g/mol, including all intermittent values and ranges therein, or in the alternative, from about 50,000 to about 750,000 g/mol, including all intermittent values and ranges therein, or in the alternative, from about 100,000 to about 500,000 g/mol, including all intermittent values and ranges therein, as determined by gel permeation chromatography (GPC).

### V. Applications (Methods of Use)

A. Pressure Sensitive Adhesives (PSAs)

Methods according to certain embodiments of the present subject matter may include applying the water-based and/or solvent-based polyester-(meth)acrylate hybrid polymer compositions according to some embodiments of the present subject matter onto a backing substrate, driving off, such as by evaporation or otherwise the continuous aqueous-based phase or aprotic solvent to form a generally uniform coating or layer of a polymerized product containing a pressure sensitive adhesive.

Backing substrates are not particularly limited by type of construction. For example, backing substrates may include compostable films utilizing a variety of known compostable resin polymers, and blends thereof, such as polylactic acid or polylactide (PLA), polybutylene succinate alone or in blends with other compostable polymeric materials. Additional compostable materials suitable as substrates of the present subject matter may include, but are not limited to, aliphatic-aromatic copolyesters, polybutylene adipate co-terephthalates (PBAT), such as ECOFLEX from BASF, or combinations thereof. In certain embodiments, for instance, a film layer, such as a facestock layer, a core layer, or a skin layer, may comprise a blend of PLA and an aliphatic-aromatic copolyester or a blend of PLA and a PBAT.

Commercially-available compostable materials suitable for use in accordance with certain embodiments of the present subject matter include ECOFLEX (CAS #60961-73-1 or CAS #55231-08-8; 1,4-Benzenedicarboxylic acid, polymer with 1,4-butanediol and hexanedioic acid) from BASF; ECOFLEX and PLA blends; Compostable 3002 (a 50-70% copolyester and PLA) from Cereplast; ECOVIO (particular blends of PLA and ECOFLEX, such as a 50/50 blend) from BASF; BioTuf 970 (a PBAT-based material) from Heritage Plastics; MATER-BI (proprietary composition, but claimed to be compostable) from Novamont; Cardia Compostable B-F (a compostable resin based on a blend of thermoplastic starch (TPS), compostable polyesters, and natural plasticizers-1,4-Benzenedicarboxylic acid, polymer with 1,4-butanediol and hexanedioic acid/TPS blends) from Cardia Bioplastics; or similar compostable plastics.

In other embodiments, backing substrates may include paper, cellophane, plastic film, such as, for example, bi-axially oriented polypropylene (BOPP) film, polyvinylchloride (PVC) film, cloth, tape, or metal foils.

B. Labelled Articles

The present subject matter also relates to articles or goods in combination with compostable adhesives such as the pressure sensitive adhesives described herein and particularly the label assemblies. Typically, the articles include one or more compostable construct/label containing a compostable film, tags, printed members, or other item that is adhered to the article using the present subject matter adhesives. In many embodiments, the label is adhered to an outer surface of the article. A wide array of articles can be utilized such as but not limited to containers such as bottles (both plastic and glass), liquid containers, food and/or beverage containers, and personal care products.

As noted previously, aqueous-based dispersions according to certain embodiments of the present subject matter provide an improvement in handling and application or deposition onto a variety of substrates, such as for making a PSA construct. This improvement in handling and application may be due, at least in part, to the relatively low viscosity of the aqueous-based dispersions according to embodiments of the present subject matter as compared to traditional warm/hot melt adhesives. For instance, the viscosity of the aqueous-based dispersions according to certain embodiments may comprise from about 5 to about 1500 cp at 20° C. or from about 5 to about 500 cp at 20° C. The relatively low viscosities of the aqueous-based dispersions according to certain embodiments ensure easier and more complete or thorough coating/coverage of a substrate for preparation of PSA constructs, such as adhesive articles. Additionally, a major advantage of water based systems is the elimination of solvents; for lower cost (water is relatively inexpensive compared to other solvents), no VOC generation during film drying, flammability issues with solvents, etc.

Backing substrates are not particularly limited by type of construction. For example, backing substrates may include compostable films utilizing a variety of known compostable resin polymers, and blends thereof, such as polylactic acid or polylactide (PLA), polybutylene succinate alone or in blends with other compostable polymeric materials. Additional compostable materials suitable as substrates of the present subject matter may include aliphatic-aromatic copolyesters, polybutylene adipate co-terephthalates (PBAT), such as ECOFLEX from BASF, or combinations thereof. In certain embodiments, for instance, a film layer, such as a facestock layer, a core layer, or a skin layer, may comprise a blend of PLA and an aliphatic-aromatic copolyester or a blend of PLA and a PBAT.

Commercially-available compostable materials suitable for use in accordance with certain embodiments of the present subject matter include ECOFLEX (CAS #60961-73-1 or CAS #55231-08-8; 1,4-Benzenedicarboxylic acid, polymer with 1,4-butanediol and hexanedioic acid) from BASF; ECOFLEX and PLA blends; Compostable 3002 (a 50-70% copolyester and PLA) from Cereplast; ECOVIO (particular blends of PLA and ECOFLEX, such as a 50/50 blend) from BASF; BioTuf 970 (a PBAT-based material) from Heritage Plastics; MATER-BI (proprietary composition, but claimed to be compostable) from Novamont; Cardia Compostable B-F (a compostable resin based on a blend of thermoplastic starch (TPS), compostable polyesters, and natural plasticizers-1,4-Benzenedicarboxylic acid, polymer with 1,4-butanediol and hexanedioic acid/TPS blends) from Cardia Bioplastics; or similar compostable plastics. The subject matter includes a compostable construct/label comprised of a compostable film and a compostable adhesive such as the pressure sensitive adhesives described herein.

In other embodiments, backing substrates may include paper, cellophane, plastic film, such as, for example, bi-axially oriented polypropylene (BOPP) film, polyvinylchloride (PVC) film, cloth, tape, or metal foils.

### EXAMPLES

The present disclosure is further illustrated by the following example, which in no way should be construed as being limiting. That is, the specific features described in the following examples are merely illustrative, and not limiting.

Polyester Macromers

### Example 1: Macromer DH7-63

To a 2 L, four-neck resin kettle equipped with a heating mantle, air purge, stirring, thermocouple and condenser were added Heloxy Modifier 8 (493.1 g), acrylic acid (25.0 g), phthalic anhydride (205.6 g), butylated hydroxytoluene (BHT) (0.4 g) and polymerization catalyst (6.0 g). The mixture was heated gradually to 120° C. and reacted together until the epoxy was consumed and the acid value was measured to be 7.7 mg KOH/gram. The viscosity of the final product was 4000 cps, with a Mn=1743 and Mw=2368. Heloxy Modifier 8 by Hexion is an aliphatic monoglycidyl ether containing alkyl chains which are predominately C12 and C14 in length. The acid value was measured by dissolving the sample in solvent and titrating with 0.1 N KOH. Viscosity was measured using Brookfield RV Viscometer.

### Example 2: Macromer DH7-67

To a 2 L, four-neck resin kettle equipped with a heating mantle, air purge, stirring, thermocouple and condenser were added ERISYS® GE-5 (416.6 g), acrylic acid (28.8 g), phthalic anhydride (354.7 g), BHT (0.4 g) and polymerization catalyst (6.0 g). The mixture was heated gradually to 120° C. and reacted together until the epoxy was consumed and the acid value was measured to be 8.5 mg KOH/gram. The final product had a bimodal molecular weight distribution and had a Mn=1578 and Mw=3405.

### Example 3: Macromer (DH7-79)

To a 2 L, four-neck resin kettle equipped with a heating mantle, air purge, stirring, thermocouple and condenser were added Heloxy Modifier 8 (600.4 g), acrylic acid (30.4 g), succinic anhydride (169.1 g), BHT (0.4 g) and benzyldimethylamine (2.0 g). The mixture was heated gradually to 120° C. and reacted together until the epoxy was consumed and the acid value was measured to be 8.0 mg KOH/gram. An additional 16.2 grams of Heloxy Modifier 8 was added and the mixture reacted until an acid value of 1.5 mg KOH/gram was obtained. The final product had a bimodal molecular weight distribution and had a Mn=3074 and Mw=6826, with a viscosity of 2870 cps.

### Example 4: Macromer (DH7-85)

To a 2 L, four-neck resin kettle equipped with a heating mantle, air purge, stirring, thermocouple and condenser were added Heloxy Modifier 8 (541.5 g), methacrylic acid (32.8 g), phthalic anhydride (225.7 g), BHT (0.4 g) and benzyldimethylamine (2.0 g). The mixture was heated gradually to 120° C. and reacted together until the epoxy was consumed and the acid value was measured to be 6.4 mg KOH/gram. The final product a Mn=1747 and Mw=3373, with a viscosity of 1205 cps.

### Example 5: Macromer (DH8-53)

To a 2 L, four-neck resin kettle equipped with a heating mantle, air purge, stirring, thermocouple and condenser were added Heloxy Modifier 8 (983.5 g), hydroxyethylacrylate (83.1 g), hexahydrophthalic anhydride (533.1 g), BHT (0.8 g) and polymerization catalyst (12.0 g). The mixture was heated gradually to 120° C. and reacted together until the epoxy was consumed and the acid value was measured to be 9.5 mg KOH/gram. The viscosity of the final product was 4070 cps, with a Mn=1697 and Mw=2410.

### Example 6: Macromer (DH8-57)

To a 2 L, four-neck resin kettle equipped with a heating mantle, air purge, stirring, thermocouple and condenser were added Heloxy Modifier 8 (1088.4 g), acrylic acid (69.0 g), hexahydrophthalic anhydride (442.6 g), BHT (0.8 g) and polymerization catalyst (12.0 g). The mixture was heated gradually to 120° C. and reacted together until the epoxy was consumed and the acid value was measured to be 7.0 mg KOH/gram. The viscosity of the final product was 1110 cps, with a Mn=1720 and Mw=2919.

### Example 7: Macromer (DH8-68)

To a 2 L, four-neck resin kettle equipped with a heating mantle, air purge, stirring, thermocouple and condenser were added Heloxy Modifier 8 (1053.1 g), methacrylic acid (79.7 g), hexahydrophthalic anhydride (428.3 g), BHT (0.8 g) and polymerization catalyst (12.0 g). The mixture was heated gradually to 120° C. and reacted together until the epoxy was consumed and the acid value was measured to be 8.5 mg KOH/gram. Acetic anhydride (94.6 g) was then added to the reactor and held at 120° C. for 2 hours, converting the hydroxyl groups to acetate esters. After the 2 hour hold, the residual acetic acid was stripped off. The viscosity of the final product was 2770 cps, with a Mn=1662 and Mw=2359.

### Example 8: Macromer (DH8-83)

To a 2 L, four-neck resin kettle equipped with a heating mantle, air purge, stirring, thermocouple and condenser were added Heloxy Modifier 8 (969.9 g), benzoic acid (104.2 g), hexahydrophthalic anhydride (394.5 g), BHT (0.8 g) and polymerization catalyst (12.0 g). The mixture was heated gradually to 120° C. and reacted together until the epoxy was consumed and the acid value was measured to be 8.2 mg KOH/gram. Methacrylic anhydride (131.1 g) was then added to the reactor and held at 120° C. for 2 hours, converting the hydroxyl groups to methacrylate esters. After the 2 hour hold, the resin was cooled down, with the methacrylic acid left in the solution. The viscosity of the final product was 1440 cps.

### Example 9: Macromer (DH9-13)

To a 2 L, four-neck resin kettle equipped with a heating mantle, air purge, stirring, thermocouple and condenser were added Heloxy Modifier 8 (954.6 g), benzoic acid (102.5 g), nadic anhydride (413.4 g), BHT (0.8 g) and polymerization catalyst (12.0 g). The mixture was heated gradually to 120° C. and reacted together until the epoxy was consumed and the acid value was measured to be 16.3 mg KOH/gram. An additional 81.0 grams of Heloxy Modifier 8 was added and the mixture reacted until an acid value of 5.7 mg KOH/gram was obtained. Methacrylic anhydride (129.4 g) was then added to the reactor and held at 120° C. for 2 hours, converting the hydroxyl groups to methacrylate esters. After the 2 hour hold, the resin was cooled down, with the methacrylic acid left in the solution. The viscosity of the final product was 1190 cps.

Mini-Emulsions

### Example 10 (DH7-65)

The macromer of example 1 (140.0 g) was mixed with butyl acrylate (46.0 g), methyl methacrylate (10.0 g), and methacrylic acid (4.0 g). Separately, a surfactant solution was made from Maxemul 6112-LQ (30.0 g), water (30.0 g) and 19% ammonia in water (0.7 g). Under high speed mixing, the surfactant solution was slowly added to the macromer solution to form a pre-emulsion. This pre-emulsion was then sonicated to form a stable mini-emulsion with a particle size of 316 nm. The mini-emulsion was then added to a five-neck jacketed resin kettle equipped with nitrogen purge, stirring, thermocouple, feed ports and condenser. The oil bath for heating the reactor was set to 60° C. While the mini-emulsion was heating up under stirring, a peroxide solution was made from 70% tert-butyl hydroperoxide (0.25 g) and water (12.0 g), along with a reducing agent solution made from Bruggolite® FF6 M (0.25 g) and water (12.0 g). After 20 minutes of heating, the batch reached a temperature of 52° C. and half of the peroxide solution and half of the reducing agent solution were added to the reactor. A peak exotherm temperature of 65° C. was obtained after 12 minutes and the mini-emulsion was then held for 15 minutes. After the 15-minute hold (reactor temperature of 62° C.), the remaining peroxide and reducing agent solutions were fed in over an hour and the batch was then held for an additional hour. During the one hour hold period, a second peroxide solution was made from 70% tert-butyl hydroperoxide (0.5 g) and water (6.0 g), along with a second reducing agent solution made from Bruggolite® FF6 M (0.5 g) and water (6.0 g). After the one hour hold, both the peroxide and reducing agent solutions were fed in over one hour. When finished, the batch was held for an additional hour and then cooled to room temperature. The liquid properties are summarized in Table 1 and the adhesive properties are summarized in Table 2.

### Example 11 (DH7-68)

The process of example 11 was repeated using the macromer of example 2 (140.0 g) blended with butyl acrylate (46.0 g), methyl methacrylate (10.0 g), and methacrylic acid (4.0 g). The surfactant solution was made from Maxemul 6112-LQ (50.0 g), water (30.0 g) and 19% ammonia in water (1.0 g). The liquid properties are summarized in Table 1 and the adhesive properties are summarized in Table 2.

### Example 12 (DH7-82)

The process of example 11 was repeated using the macromer of example 3 (140.0 g) blended with butyl acrylate (22.0 g), ethyl acrylate (34.0 g), and methacrylic acid (4.0 g). The surfactant solution was made from Maxemul 6112-LQ (30.0 g), water (30.0 g) and 19% ammonia in water (1.0 g). The liquid properties are summarized in Table 1 and the adhesive properties are summarized in Table 2.

### Example 13 (DH7-87)

The process of example 11 was repeated using the macromer of example 4 (140.0 g) blended with butyl acrylate (22.0 g), ethyl acrylate (34.0 g), and methacrylic acid (4.0 g). The surfactant solution was made from Maxemul 6112-LQ (30.0 g), water (30.0 g) and 19% ammonia in water (1.0 g). The liquid properties are summarized in Table 1 and the adhesive properties are summarized in Table 2.

### Example 14 (DH8-54)

The macromer of example 5 (714.0 g) was mixed with butyl acrylate (265.2 g), methacrylic acid (40.8 g) and acetone (76.5 g). Separately, a surfactant solution was made from Maxemul 6112-LQ (153.0 g), water (551.8 g) and 19% ammonia in water (10.2 g). Under high speed mixing, the surfactant solution was slowly added to the macromer solution to form a pre-emulsion. This pre-emulsion was then homogenized (2 passes) to form a stable mini-emulsion with a particle size of 245 nm. Part of the mini-emulsion (155.79 g) and water (145.38 g) was then added to a five-neck jacketed resin kettle equipped with nitrogen purge, stirring, thermocouple, feed ports and condenser. The oil bath for heating the reactor was set to 60° C. While the mini-emulsion was heating up under stirring, a peroxide solution was made from 70% tert-butyl hydroperoxide (0.15 g) and water (1.46 g), along with a reducing agent solution made from Bruggolite® FF6 M (0.15 g) and water (1.46 g). After 30 minutes of heating, the batch reached a temperature of 53° C. and both the peroxide solution and the reducing agent solution were added to the reactor. A peak exotherm temperature of 59° C. was obtained after 16 minutes and the mini-emulsion was then held for 15 minutes. A second peroxide solution was made from 70% tert-butyl hydroperoxide (1.55 g) and water (61.2 g), along with a second reducing agent solution made from Bruggolite® FF6 M (1.55 g) and water (61.2 g). After the 15-minute hold (reactor temperature of 56° C.), the remainder of the mini-emulsion (1655.73 g) was fed in over a three-hour period while the second peroxide and reducing agent solutions were fed in simultaneously over a four-hour period. After the feeds were complete, the batch was then held for an additional hour. During the one hour hold period, a third peroxide solution was made from 70% tert-butyl hydroperoxide (1.02 g) and water (20.4 g), along with a third reducing agent solution made from Bruggolite® FF6 M (1.02 g) and water (20.4 g). After the one hour hold, both the peroxide and reducing agent solutions were fed in over one hour. When finished, the batch was held for an additional hour and then cooled to room temperature. The liquid properties are summarized in Table 1 and the adhesive properties are summarized in Table 2.

### Example 15 (DH8-61)

The macromer of example 6 (714.0 g) was mixed with butyl acrylate (163.2 g), butyl methacrylate (102.0 g) and methacrylic acid (40.8 g). Separately, a surfactant solution was made from Maxemul 6112-LQ (153.0 g), water (628.32 g) and 19% ammonia in water (10.2 g). Under high speed mixing, the surfactant solution was slowly added to the macromer solution to form a pre-emulsion. This pre-emulsion was then homogenized (2 passes) to form a stable mini-emulsion with a particle size of 296 nm. Part of the mini-emulsion (130.43 g) and water (172.14 g) was then added to a five-neck jacketed resin kettle equipped with nitrogen purge, stirring, thermocouple, feed ports and condenser. The oil bath for heating the reactor was set to 60° C. While the mini-emulsion was heating up under stirring, a peroxide solution was made from 70% tert-butyl hydroperoxide (0.05 g) and water (0.48 g), along with a reducing agent solution made from Bruggolite® FF6 M (0.05 g) and water (0.48 g). After 30 minutes of heating, the batch reached a temperature of 52° C. and both the peroxide solution and the reducing agent solution were added to the reactor. A peak exotherm temperature of 55° C. was obtained after 5 minutes and the mini-emulsion was then held for 15 minutes. A second peroxide solution was made from 70% tert-butyl hydroperoxide (0.63 g) and water (61.2 g), along with a second reducing agent solution made from Bruggolite® FF6 M (0.63 g) and water (61.2 g). After the 15-minute hold (reactor temperature of 55° C.), the remainder of the mini-emulsion (1681.09 g) was fed in over a three-hour period while the second peroxide and reducing agent solutions were fed in simultaneously over a four-hour period. After the feeds were complete, the batch was then held for an additional hour. During the one hour hold period, a third peroxide solution was made from 70% tert-butyl hydroperoxide (1.01 g) and water (20.4 g), along with a third reducing agent solution made from Bruggolite® FF6 M (1.01 g) and water (20.4 g). After the one hour hold, both the peroxide and reducing agent solutions were fed in over one hour. When finished, the batch was held for an additional hour and then cooled to room temperature. The liquid properties are summarized in Table 1 and the adhesive properties are summarized in Table 2.

### Example 16 (DH8-79)

The macromer of example 7 (714.0 g) was mixed with butyl acrylate (163.2 g), methyl acrylate (102.0 g), acrylic acid (20.4 g), methacrylic acid (20.4 g) and isopropanol (153.0 g). Separately, a surfactant solution was made from Maxemul 6112-LQ (153.0 g), water (414.63 g) and 19% ammonia in water (10.2 g). Under high speed mixing, the surfactant solution was slowly added to the macromer solution to form a pre-emulsion. This pre-emulsion was then homogenized (2 passes) to form a stable mini-emulsion with a particle size of 264 nm. Part of the mini-emulsion (145.7 g) and water (155.47 g) was then added to a five-neck jacketed resin kettle equipped with nitrogen purge, stirring, thermocouple, feed ports and condenser. The oil bath for heating the reactor was set to 60° C. While the mini-emulsion was heating up under stirring, a peroxide solution was made from 70% tert-butyl hydroperoxide (0.09 g) and water (0.94 g), along with a reducing agent solution made from Bruggolite® FF6 M (0.09 g) and water (0.94 g). After 30 minutes of heating, the batch reached a temperature of 52° C. and both the peroxide solution and the reducing agent solution were added to the reactor. A peak exotherm temperature of 57° C. was obtained after 10 minutes and the mini-emulsion was then held for 15 minutes. A second peroxide solution was made from 70% tert-butyl hydroperoxide (1.0 g) and water (61.2 g), along with a second reducing agent solution made from Bruggolite® FF6 M (1.0 g) and water (61.2 g). After the 15-minute hold (reactor temperature of 56° C.), the remainder of the mini-emulsion (1548.52 g) was fed in over a three-hour period while the second peroxide and reducing agent solutions were fed in simultaneously over a four-hour period. After the feeds were complete, the batch was then held for an additional hour. During the one hour hold period, a third peroxide solution was made from 70% tert-butyl hydroperoxide (0.66 g) and water (20.4 g), along with a third reducing agent solution made from Bruggolite® FF6 M (0.66 g) and water (20.4 g). After the one hour hold, both the peroxide and reducing agent solutions were fed in over one hour. When finished, the batch was held for an additional hour and then cooled to room temperature. The liquid properties are summarized in Table 1 and the adhesive properties are summarized in Table 2.

### Example 17 (DH8-86)

The macromer of example 8 (748.2 g) was mixed with butyl acrylate (163.2 g), methyl acrylate (102.0 g) and methacrylic acid (6.6 g). Separately, a surfactant solution was made from Maxemul 6112-LQ (153.0 g), water (567.3 g) and 19% ammonia in water (10.2 g). Under high speed mixing, the surfactant solution was slowly added to the macromer solution to form a pre-emulsion. This pre-emulsion was then homogenized (2 passes) to form a stable mini-emulsion with a particle size of 262 nm. Part of the mini-emulsion (150.57 g) and water (150.6 g) was then added to a five-neck jacketed resin kettle equipped with nitrogen purge, stirring, thermocouple, feed ports and condenser. The oil bath for heating the reactor was set to 60° C. While the mini-emulsion was heating up under stirring, a peroxide solution was made from 70% tert-butyl hydroperoxide (0.06 g) and water (0.59 g), along with a reducing agent solution made from Bruggolite® FF6 M (0.06 g) and water (0.59 g). After 30 minutes of heating, the batch reached a temperature of 54° C. and both the peroxide solution and the reducing agent solution were added to the reactor. A peak exotherm temperature of 59° C. was obtained after 9 minutes and the mini-emulsion was then held for 15 minutes. A second peroxide solution was made from 70% tert-butyl hydroperoxide (0.62 g) and water (61.2 g), along with a second reducing agent solution made from Bruggolite® FF6 M (0.62 g) and water (61.2 g). After the 15-minute hold (reactor temperature of 58° C.), the remainder of the mini-emulsion (1600.26 g) was fed in over a three-hour period while the second peroxide and reducing agent solutions were fed in simultaneously over a four-hour period. After the feeds were complete, the batch was then held for an additional hour. During the one hour hold period, a third peroxide solution was made from 70% tert-butyl hydroperoxide (1.02 g) and water (20.4 g), along with a third reducing agent solution made from Bruggolite® FF6 M (1.02 g) and water (20.4 g). After the one hour hold, both the peroxide and reducing agent solutions were fed in over one hour. When finished, the batch was held for an additional hour and then cooled to room temperature. The liquid properties are summarized in Table 1 and the adhesive properties are summarized in Table 2.

### Example 18 (DH11-21 A, Solution Acrylic Base Resin)

A mixture of butyl acrylate (92.8 g), acrylic acid (7.2 g), acetone (40.0 g) and toluene (100 g) was made and added to a five-neck jacketed resin kettle equipped with nitrogen purge, stirring, thermocouple, feed ports and condenser. The oil bath for heating the reactor was set to 85° C. While the monomer/solvent solution was heating up under stirring, a peroxide solution was made from lauryl peroxide (0.2 g) and toluene (9.8 g). Separately, a mixture of butyl acrylate (658.9 g), acrylic acid (51.1 g), n-dodecylmercaptan (0.7 g), lauryl peroxide (1.4 g) and toluene (657.9 g) was also made. After 35 minutes of heating, the batch reached a temperature of 81° C. and was allowed to reflux for 10 minutes before adding the peroxide solution to the reactor. A peak exotherm temperature of 92° C. was obtained after 12 minutes and held for an additional 3 minutes before feeding the main monomer/solvent/peroxide solution over a 3-hour time period. After the feed was complete, the batch was held for an hour. During the one hour hold period, a second peroxide solution was made from tert-amyl peroxypivalate (2.4 g) and toluene (101.0 g). After the one hour hold, the second peroxide solution was fed in over 30 minutes. When the peroxide feed was finished, the batch was held for an additional 30 minutes and then cooled to room temperature. The viscosity of the final product was 13,800 cps at 45% NV.

### Example 19 (DH11-21 B, Macromer Modified Acrylic)

To a 2 L, four-neck resin kettle equipped with a heating mantle, nitrogen purge, stirring, thermocouple and condenser were added the solution acrylic resin from Example 18 (274.7 g), Heloxy 8 (248.3 g), phthalic anhydride (128.1 g), benzyldimethylamine (2 g) and toluene (348.9 g). The mixture was heated gradually to 120° C. and reacted together until the epoxy was consumed and the acid value was measured to be 14.9 mg KOH/gram. The resin was cooled down and the viscosity of the final product was 290 cps at 55.2% non-volatiles. For adhesion testing, 46.82 grams of example 19 was mixed with 1.68 grams of an aluminum acetylacetonate solution (1:3:9 ratio of aluminum acetylacetonate/2,4-pentanedione/toluene) and 1.50 grams of CX-100 (10% solution in toluene). 18 gsm films were then made and evaluated for their adhesion properties.

### Example 20 (DH11-25, Macromer Modified Acrylic)

To a 2 L, four-neck resin kettle equipped with a heating mantle, nitrogen purge, stirring, thermocouple and condenser were added the solution acrylic resin from Example 18 (278.6 g), Heloxy 5 (224.2 g), succinic anhydride (150.5 g), benzyldimethylamine (2 g) and toluene (346.8 g). The mixture was heated gradually to 120° C. and reacted together until the epoxy was consumed and the acid value was measured to be 23.4 mg KOH/gram. The resin was cooled down and poured out from the reactor. For adhesion testing, 46.90 grams of example 20 was mixed with 1.63 grams of an aluminum acetylacetonate solution (1:3:9 ratio of aluminum acetylacetonate/2,4-pentanedione/toluene) and 1.47 grams of CX-100 (10% solution in toluene). 18 gsm films were then made and evaluated for their adhesion properties.

### Example 21 (DH11-27, Macromer Modified Acrylic)

To a 2 L, four-neck resin kettle equipped with a heating mantle, nitrogen purge, stirring, thermocouple and condenser were added the solution acrylic resin from Example 18 (444.3 g), Heloxy 8 (132.0 g), phthalic anhydride (68.1 g), benzyldimethylamine (1 g) and toluene (155.6 g). The mixture was heated gradually to 120° C. and reacted together until the epoxy was consumed and the acid value was measured to be 35.0 mg KOH/gram. The resin was cooled down and the viscosity of the final product was 6,200 cps at 40.7% non-volatiles. For adhesion testing, 49.04 grams of example 21 was mixed with 0.96 grams of an aluminum acetylacetonate solution (1:3:9 ratio of aluminum acetylacetonate/2,4-pentanedione/toluene). 18 gsm films were then made and evaluated for their adhesion properties.

TABLE 1

| | | Viscosity | | Particle |
|---|---|---|---|---|
| TABLE 1 | % Non-Volatiles | (cps) | pH | Size (nm) |
| Example 10 | 50.3 | 46 | 5.1 | 328 |
| Example 11 | 48.9 | 44 | 4.7 | 437 |
| Example 12 | 49.8 | 45 | 5.5 | 385 |
| Example 13 | 49.7 | 42 | 5.1 | 363 |
| Example 14 | 49.1 | 42 | 6.0 | 253 |
| Example 15 | 45.8 | 43 | 5.8 | 315 |
| Example 16 | 49.2 | 52 | 5.0 | 305 |
| Example 17 | 49.6 | 79 | 6.2 | 391 |

TABLE 2

| | 90° | 90° | 90° | 90° | | Loop | Loop |
|---|---|---|---|---|---|---|---|
| | Peel | Peel | Peel | Peel | Shear | Tack | Tack |
| TABLE 2 | (SS) | (Cardboard) | (HDPE) | (Glass) | (1″ × 1″ × 1 Kg) | (SS) | (Glass) |
| Example 10 | 7.1 | 2.6 | 3.5 | 8.4 | 1174 | 6.0 | 5.2 |
| Example 11 | 10.9 | Tore cardboard | 0.00 | 12.7 | 705 | 12.9 | 14.3 |
| Example 12 | 2.0 | 0.3 | 0.2 | 2.2 | 10000 | 1.2 | 1.3 |
| Example 13 | 7.1 | 3.5 | 2.2 | 6.9 | 2447 | 4.0 | 4.7 |
| Example 14 | 7.2 | 6.0 | 3.9 | 6.9 | 9 | 8.5 | 8.0 |
| Example 15 | 5.9 | 2.4 | 2.0 | 6.0 | 196 | 3.7 | 3.5 |
| Example 16 | 8.5 | 5.6 | 2.4 | 8.2 | 14 | 4.9 | 6.0 |
| Example 17 | 1.0 | 0.4 | 0.7 | 1.4 | 10000 | 2.8 | 3.3 |
| Example 19 | 4.2 | 2.2 | — | 2.0 | — | 5.2 | 5.8 |
| Example 20 | 1.4 | 0.5 | 2.0 | 1.3 | 99 | 2.8 | 2.3 |
| Example 21 | 3.6 | 1.3 | — | 1.6 | — | 4.3 | 3.1 |

*All mini-emulsions examples (10-17) were adjusted with ammonia to a pH of 8-9 to raise viscosity to a level suitable for coating. 18 gsm films were then made and evaluated for their adhesion properties.
* 24-hour dwell for all the peel tests

In table 2, the units for the peel tests and the loop tack tests are in N/in. The shear test is in minutes to failure.

These and other modifications and variations to the present subject matter may be practiced by those of ordinary skill in the art without departing from the spirit and scope of the present subject matter, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the subject matter as further described in such appended claims. Therefore, the spirit and scope of the appended claims should not be limited to the exemplary description of the versions contained herein.

Many other benefits will no doubt become apparent from future application and development of this technology.

Further examples consistent with the present teachings are set out in the following number clauses.

Clause 1. A polyester-(meth)acrylate hybrid polymer composition comprising:

a polyester portion covalently bound to a (meth)acrylate portion, the polyester portion comprising an alternating copolymer comprising repeating (AB) units or (BA) units or a combination thereof, wherein (A) is an epoxide and (B) is an anhydride (B), and the (meth)acrylate portion comprising a (meth)acrylate polymer,

wherein the polyester portion is present in the polyester-(meth)acrylate hybrid polymer at a level of about 5% to about 95% by weight, based on the total weight of the polyester-(meth)acrylate hybrid polymer.

Clause 2. The composition of clause 1, wherein the polyester portion comprises up to 50 repeating (AB) or (BA) units or a combination thereof.

Clause 3. The composition of clause 1 or 2, wherein the weight ratio of the polyester portion to the (meth)acrylate portion is within the range of from about 5:95 to about 95:5 of the polyester-(meth)acrylate hybrid polymer.

Clause 4. The composition of any one of clauses 1-3, wherein the weight ratio of the polyester portion comprises a majority proportion of the polyester-(meth)acrylate hybrid polymer.

Clause 5. The composition of any one of clauses 1-4, wherein the weight ratio of the polyester portion to the (meth)acrylate portion is within the range of from about 50:50 to about 95:5 of the polyester-(meth)acrylate hybrid polymer.

Clause 6. The composition of any one of clauses 1-5, wherein the weight ratio of the polyester portion to the (meth)acrylate portion is within the range of from about 70:30 to about 95:5 of the polyester-(meth)acrylate hybrid polymer.

Clause 7. The composition of any one of clauses 1-6, further comprising one or more tackifiers.

Clause 8. The composition of any one of clauses 1-7 comprising

about 50-95 wt % polyester portion;

about 5-50 wt % (meth)acrylate portion; and

about 0-50 wt % one or more tackifiers,
wherein the weight % of the components sum up to a total of 100% based on the total weight of the polyester-(meth)acrylate hybrid polymer composition.

Clause 9. The composition of any one of clauses 1-8, wherein the polyester portion comprises units that are a reaction product of one or more ethylenically unsaturated monomers, one or more epoxides, and one or more anhydrides.

Clause 10. The composition of clause 9, wherein the one or more ethylenically unsaturated monomers comprise an α,β-unsaturated monomer.

Clause 11. The composition of clauses 9 or 10, wherein the one or more ethylenically unsaturated monomer is a monomer selected from the group consisting of acrylic acid, methacrylic acid, crotonic acid, hydroxyl alkyl (meth)acrylate, glycidyl (meth)acrylate, (meth)acrylic anhydride, and combinations thereof.

Clause 12. The composition of any one of clauses 9-11, wherein the one or more epoxides comprises a monoepoxide.

Clause 13. The composition of any one of clauses 9-12, wherein the one or more epoxides is a compound selected from the group consisting of aliphatic alcohol glycidyl ethers having 1 to 22 carbon atoms, glycidyl esters of aliphatic carboxylic acids containing from 1 to 22 carbon atoms, glycidyl esters of aromatic carboxylic acids, alkyl substituted glycidyl esters of aromatic carboxylic acids, aryl substituted glycidyl esters of aromatic carboxylic acids, aromatic glycidyl ethers, alkyl substituted aromatic glycidyl ethers, aryl substituted aromatic glycidyl ethers, terpene based mono-epoxides, alpha olefin based mono-epoxides, oxetane, alkylated derivatives of oxetanes, epoxidized mono-unsaturated fatty acid esters, epoxidized mono-unsaturated fatty alcohol esters, glycidyl amine compound(s), and combinations thereof.

Clause 14. The composition of clause 13, wherein the aliphatic alcohol glycidyl ethers are compounds selected from the group consisting of butyl glycidyl ether, 2-ethylhexyl glycidyl ether, C8-C10 alcohol glycidyl ethers, C12-C14 alcohol glycidyl ethers, and combinations thereof.

Clause 15. The composition of clauses 13, wherein the glycidyl esters of aliphatic carboxylic acids comprises a glycidyl ester of neodecanoic acid or rosin acid.

Clause 16. The composition of clause 13, wherein the glycidyl esters of aromatic carboxylic acids comprises a glycidyl ester of benzoic acid.

Clause 17. The composition of clause 13, wherein the aromatic glycidyl ethers are selected from the group consisting of phenyl glycidyl ether, (o,m,p)-cresol glycidyl ethers, p-tert butyl phenol glycidyl ether, cardanol based glycidyl ethers, and combinations thereof.

Clause 18. The composition of any one of clauses 9-17, wherein the one or more anhydrides is selected from the group consisting of an aliphatic anhydride, an aromatic anhydride, and combinations thereof.

Clause 19. The composition of any one of clauses 9-18, wherein the one or more anhydrides is selected from the group consisting of succinic anhydride, maleic anhydride, glutaric anhydride, phthalic anhydride, tetrahydrophthalic anhydride, hexahydrophthalic anhydride, methyl hexahydrophthalic anhydride, nadic anhydride, methyl nadic anhydride, naphthalic anhydride, trimellitic anhydride, diglycolic anhydride, and combinations thereof.

Clause 20. The composition of any one of clauses 1-19, wherein the weight average molecular weight (Mw) of the polyester portion is within a range of from about 300 to about 20,000 g/mol as determined by gel permeation chromatography (GPC).

Clause 21. The composition of any one of clauses 1-20, wherein the polyester portion exhibits a glass transition temperature (Tg) within a range of from about −100° C. to about 150° C. measured by differential scanning calorimetry (DSC).

Clause 22. The composition of any one of clauses 1-21, wherein the polyester portion comprises a polyester macromer or a polyester oligomer.

Clause 23. The composition of any one of clauses 1-22, wherein the polyester portion contains one terminal ethylenically unsaturated group.

Clause 24. The composition of any one of clauses 1-23, wherein the (meth)acrylate polymer is prepared from at least one of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, and vinyl monomers.

Clause 25. The composition of any one of clauses 1-24, wherein the (meth)acrylate polymer is prepared from at least one monomer selected from the group consisting of acrylic acid, methacrylic acid, crotonic acid, crotonate esters, itaconic acid, itaconate esters, fumaric acid, fumarate esters, maleic acid, maleate esters, maleic anhydride, hydroxyl alkyl (meth)acrylate, hydroxyethyl (meth)acrylate, hydroxypropyl (meth)acrylate, hydroxybutyl (meth)acrylate, glycidyl (meth)acrylate, (meth)acrylic anhydride, isobornyl (meth)acrylate, aminoethyl methacrylate, N,N-dimethyl aminoethyl methacrylate, urea/ureido methacrylate, acrylonitrile, methacrylonitrile, acrylamide, methacrylamide, N,N-dimethylacrylamide, methyl acrylate, methyl methacrylate, ethyl acrylate, ethyl methacrylate, butyl acrylate, butyl methacrylate, propyl acrylate, propyl methacrylate, 2-ethylhexyl acrylate, 2-ethylhexyl methacrylate, lauryl acrylate, lauryl methacrylate, iso-octyl acrylate, iso-octyl methacrylate, iso-decyl acrylate, iso-decyl methacrylate, stearyl acrylate, stearyl methacrylate, vinyl propionate, styrene, alkyl-substituted styrenes, vinyl acetate, vinyl chloride, and N-vinyl pyrrolidone.

Clause 26. The composition of any one of clauses 1-25, wherein the polyester-(meth)acrylate hybrid polymer contains a photoinitiator moiety in the form of a distinct agent that is added to the composition, or a photoinitiator moiety bound to the polymer backbone, or a photoinitiator moiety formed in-situ by an association of materials or agents in the composition.

Clause 27. The composition of clause 26, wherein the photoinitiator is selected from the group consisting of acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof.

Clause 28. The composition of clause 26 or 27, wherein the photoinitiator is activatable upon exposure to UV radiation to at least partially polymerize and/or crosslink the composition.

Clause 29. The composition of any one of clauses 1-28, wherein the (meth)acrylate polymer exhibits a glass transition temperature (Tg) within a range of from about −100° C. to about 150° C. measured by differential scanning calorimetry (DSC).

Clause 30. The composition of any one of clauses 1-29, wherein the weight average molecular weight (Mw) of the (meth)acrylate polymer is within a range of from about 5,000 to about 1,000,000 g/mol as determined by gel permeation chromatography (GPC).

Clause 31. The composition of any one of clauses 1-30, wherein the composition further comprises additives selected from the group consisting of pigments, fillers, plasticizers, diluents, antioxidants, waxes, tackifiers, crosslinkers, and combinations thereof.

Clause 32. The composition of any one of clauses 1-31, wherein the polyester-(meth)acrylate hybrid polymer exhibits a single glass transition temperature (Tg) within a range of from about −100° C. to about 150° C. measured by differential scanning calorimetry (DSC).

Clause 33. The composition of any one of clauses 1-31, wherein the polyester portion and the (meth)acrylate portion are phase separated.

Clause 34. The composition of clause 33, wherein the polyester-(meth)acrylate hybrid polymer exhibits at least two glass transition temperatures (Tgs) within a range of from about −100° C. to about 150° C. measured by differential scanning calorimetry (DSC).

Clause 35. The composition of any one of clauses 1-34, wherein the weight average molecular weight (Mw) of the polyester-(meth)acrylate hybrid polymer is within a range of from about 5,000 to about 1,000,000 g/mol as determined by gel permeation chromatography (GPC).

Clause 36. A solvent-based polyester-(meth)acrylate hybrid polymer composition comprising:

the polyester-(meth)acrylate hybrid polymer composition of any one of clauses 1-35, wherein the polyester-(meth)acrylate hybrid polymer comprises a reaction product of the (meth)acrylate polymer optionally dissolved in an aprotic solvent, the one more epoxides, the one or more anhydrides, an epoxy catalyst, and optionally a free radical inhibitor to form a side chain of the polyester oligomer covalently bound to the (meth)acrylate polymer, wherein the (meth)acrylate polymer contains an acid and/or an alcohol functional group on the polymer backbone.

Clause 37. A water-dispersible composition comprising:

particles comprising the polyester-(meth)acrylate hybrid polymer according to any one of clauses 1-35,

wherein the polyester-(meth)acrylate hybrid polymer comprises a reaction product of the polyester macromer and at least one ethylenically unsaturated monomer, wherein the reaction is a free radical polymerization reaction.

Clause 38. The composition of clause 37, wherein the at least one ethylenically unsaturated monomer is a monomer selected from the group consisting of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, and vinyl monomers, and combinations thereof.

Clause 39. The composition of clause 37 or 38, wherein the at least one ethylenically unsaturated monomer is a monomer selected from the group consisting of acrylic acid, methacrylic acid, crotonic acid, crotonate esters, itaconic acid, itaconate esters, fumaric acid, fumarate esters, maleic acid, maleate esters, maleic anhydride, hydroxyl alkyl (meth)acrylate, hydroxyethyl (meth)acrylate, hydroxypropyl (meth)acrylate, hydroxybutyl (meth)acrylate, glycidyl (meth)acrylate, (meth)acrylic anhydride, isobornyl (meth)acrylate, aminoethyl methacrylate, N,N-dimethyl aminoethyl methacrylate, urea/ureido methacrylate, acrylonitrile, methacrylonitrile, acrylamide, methacrylamide, N,N-dimethylacrylamide, methyl acrylate, methyl methacrylate, ethyl acrylate, ethyl methacrylate, butyl acrylate, butyl methacrylate, propyl acrylate, propyl methacrylate, 2-ethylhexyl acrylate, 2-ethylhexyl methacrylate, lauryl acrylate, lauryl methacrylate, iso-octyl acrylate, iso-octyl methacrylate, iso-decyl acrylate, iso-decyl methacrylate, stearyl acrylate, stearyl methacrylate, vinyl propionate, styrene, alkyl-substituted styrenes, vinyl acetate, vinyl chloride, and N-vinyl pyrrolidone.

Clause 40. The composition of any one of clauses 37-39, wherein the average particle size diameter is in the range of about 50 nm to about 600 nm measured by Dynamic Light Scattering.

Clause 41. The composition of any one of clauses 37-40, wherein the average particle size diameter is in the range of about 200 nm to about 500 nm measure by Dynamic Light Scattering.

Clause 42. A pressure sensitive adhesive comprising the composition of any one of clauses 1-41 and one or more crosslinkers.

Clause 43. The pressure sensitive adhesive of clause 42, wherein the pressure sensitive adhesive exhibits a plateau shear modulus at 25° C. and 1 radian per second that is between 5×10⁴ and 6×10⁶ dynes/cm² as determined by dynamic mechanical analysis (DMA).

Clause 44. The pressure sensitive adhesive of clause 42 or 43, wherein the pressure sensitive adhesive exhibits at least one glass transition temperature (Tg) within a range of from about −100° C. to about 150° C. measured by differential scanning calorimetry (DSC).

Clause 45. An article comprising the pressure sensitive adhesive of any one of clauses 42-44.

Clause 46. The article of clause 45 further comprising:

a substrate defining a face;

wherein the pressure sensitive adhesive is disposed on at least a portion of the face of the substrate.

Clause 47. A polyester macromer comprising:

an alternating copolymer comprising up to 50 repeating (AB) units or (BA) units or a combination thereof, wherein (A) is an epoxide and (B) is an anhydride (B), and the (meth)acrylate portion comprising a (meth)acrylate polymer,

wherein the repeating units are a reaction product of one or more ethylenically unsaturated monomers, one or more epoxides, one or more anhydrides, an epoxy catalyst, and optionally a free radical inhibitor.

Clause 48. The polyester macromer of clause 47, wherein the one or more ethylenically unsaturated monomer comprises an α,β-unsaturated monomer.

Clause 49. The polyester macromer of clauses 47 or 48, wherein the one or more ethylenically unsaturated monomer is a monomer selected from the group consisting of acrylic acid, methacrylic acid, crotonic acid, hydroxyl alkyl (meth)acrylate, glycidyl (meth)acrylate, (meth)acrylic anhydride, and combinations thereof.

Clause 50. The polyester macromer of any one of clauses 47-49, wherein the one or more epoxides comprises a monoepoxide.

Clause 51. The polyester macromer of any one of clauses 47-50, wherein the one or more epoxides is a compound selected from the group consisting of aliphatic alcohol glycidyl ethers having 1 to 22 carbon atoms, glycidyl esters of aliphatic carboxylic acids containing from 1 to 22 carbon atoms, glycidyl esters of aromatic carboxylic acids, alkyl substituted glycidyl esters of aromatic carboxylic acids, aryl substituted glycidyl esters of aromatic carboxylic acids, aromatic glycidyl ethers, alkyl substituted aromatic glycidyl ethers, aryl substituted aromatic glycidyl ethers, terpene based mono-epoxides, alpha olefin based mono-epoxides, oxetane, alkylated derivatives of oxetanes, epoxidized mono-unsaturated fatty acid esters, epoxidized mono-unsaturated fatty alcohol esters, glycidyl amine compound(s), and combinations thereof.

Clause 52. The polyester macromer of clause 51, wherein the aliphatic alcohol glycidyl ethers are selected from the group consisting of butyl glycidyl ether, 2-ethylhexyl glycidyl ether, C8-C10 alcohol glycidyl ethers, C12-C14 alcohol glycidyl ethers, and combinations thereof.

Clause 53. The polyester macromer of clauses 51, wherein the glycidyl esters of aliphatic carboxylic acids comprises a glycidyl ester of neodecanoic acid or rosin acid.

Clause 54. The polyester macromer of clause 51, wherein the glycidyl esters of aromatic carboxylic acids comprises a glycidyl ester of benzoic acid.

Clause 55. The polyester macromer of clause 51, wherein the aromatic glycidyl ethers are selected from the group consisting of phenyl glycidyl ether, (o,m,p)-cresol glycidyl ethers, p-tert butyl phenol glycidyl ether, cardanol based glycidyl ethers, and combinations thereof.

Clause 56. The polyester macromer of any one of clauses 47-55, wherein the one or more anhydrides is selected from the group consisting of an aliphatic anhydride, an aromatic anhydride, and combinations thereof.

Clause 57. The polyester macromer of any one of clauses 47-56, wherein the one or more anhydrides is selected from the group consisting of succinic anhydride, maleic anhydride, glutaric anhydride, phthalic anhydride, tetrahydrophthalic anhydride, hexahydrophthalic anhydride, methyl hexahydrophthalic anhydride, nadic anhydride, methyl nadic anhydride, naphthalic anhydride, trimellitic anhydride, diglycolic anhydride, and combinations thereof.

Clause 58. The polyester macromer of any one of clauses 47-57, wherein the polyester macromer contains one terminal ethylenically unsaturated group.

Clause 59. The polyester macromer of any one of clauses 47-58, wherein the polyester macromer exhibits a glass transition temperature (Tg) within a range of from about −100° C. to about 150° C. measured by differential scanning calorimetry (DSC).

Clause 60. The polyester macromer of any one of clauses 47-59, wherein the weight average molecular weight (Mw) of the polyester macromer is within a range of from about 300 to about 20,000 g/mol as determined by gel permeation chromatography (GPC).

Clause 61. A method for producing a polyester macromer comprising:

polymerizing a monomer mixture comprising one or more ethylenically unsaturated monomers, one or more epoxides, one or more anhydrides, an epoxy catalyst, and optionally a free radical inhibitor to form a terminally ethylenically unsaturated polyester macromer copolymer.

Clause 62. The method of clause 61, wherein the polymerization of the polyester macromer is initiated with an ethylenically unsaturated monomer containing an acid or an alcohol-functional group or terminated with an ethylenically unsaturated monomer.

Clause 63. The method of clause 61, wherein the polymerization of the polyester macromer is initiated with a tertiary amine-containing protic compound or a tertiary phosphine-containing protic compound.

Clause 64. The method of clause 61, wherein the polymerization of the polyester macromer is initiated with a quaternary ammonium-containing protic compound or a quaternary phosphonium containing protic compound.

Clause 65. The method of clause 61, wherein the polymerization of the polyester macromer is initiated with a non-ethylenically unsaturated alcohol and the polymerization of the polyester macromer is terminated with the one or more ethylenically unsaturated monomers.

Clause 66. The method of clause 65, wherein the non-ethylenically unsaturated alcohol is selected from the group consisting of linear or branched aliphatic alcohols having C1 to C22 carbon atoms, cyclic aliphatic (alicyclic) alcohols having at least three carbon rings, cyclic aliphatic (alicyclic) alcohols having one or more aliphatic side chains attached, aromatic alcohols, mono-phenolic compounds, aliphatic or aromatic substituted phenol groups, and combinations thereof.

Clause 67. The method of clause 61, wherein the polymerization of the polyester macromer is initiated with a non-ethylenically unsaturated carboxylic acid and the polymerization of the polyester macromer is terminated with the one or more ethylenically unsaturated monomers.

Clause 68. The method of clause 67, wherein the non-ethylenically unsaturated carboxylic acid is selected from the group consisting of linear or branched aliphatic carboxylic acids having C1 to C22 carbon atoms, cyclic aliphatic (alicyclic) carboxylic acids having at least three carbon rings, aromatic acid, cyclic aliphatic (alicyclic) carboxylic acids having one or more aliphatic side chains attached, aliphatic or aromatic substituted aromatic acids, polycyclic acids, and combinations thereof.

Clause 69. The method of clause 61, wherein the polymerization of the polyester macromer is initiated with a non-ethylenically unsaturated secondary amine and the polymerization of the polyester macromer is terminated with the one or more ethylenically unsaturated monomers.

Clause 70. The method of clause 69, wherein the non-ethylenically unsaturated secondary amine is selected from the group consisting of linear or branched aliphatic secondary amines having C1 to C22 carbon atoms, cyclic aliphatic (alicyclic) secondary amines having at least three carbon rings, cyclic aliphatic (alicyclic) secondary amines having one or more aliphatic side chains attached, aromatic secondary amines, aliphatic or aromatic substituted aromatic secondary amines, and combinations thereof.

Clause 71. The method of clause 61, wherein the epoxy catalyst initiates the polymerization of the polyester macromer and catalyzes the reaction between the one or more epoxides and the one or more anhydrides.

Clause 72. The method of any one of clauses 61-71, wherein the one or more ethylenically unsaturated monomers comprises an α,β-unsaturated monomer.

Clause 73. The method of any one of clauses 61-72, wherein the one or more ethylenically unsaturated monomers is selected from the group consisting of acrylic acid, methacrylic acid, crotonic acid, hydroxyl alkyl (meth)acrylate, glycidyl (meth)acrylate, (meth)acrylic anhydride, and combinations thereof.

Clause 74. The method of any one of clauses 61-73, wherein the one or more epoxides comprises a monoepoxide.

Clause 75. The method of any one of clauses 61-74, wherein the one or more epoxides is a compound selected from the group consisting of aliphatic alcohol glycidyl ethers having 1 to 22 carbon atoms, glycidyl esters of aliphatic carboxylic acids containing from 1 to 22 carbon atoms, glycidyl esters of aromatic carboxylic acids, alkyl substituted glycidyl esters of aromatic carboxylic acids, aryl substituted glycidyl esters of aromatic carboxylic acids, aromatic glycidyl ethers, alkyl substituted aromatic glycidyl ethers, aryl substituted aromatic glycidyl ethers, terpene based mono-epoxides, alpha olefin based mono-epoxides, oxetane, alkylated derivatives of oxetanes, epoxidized mono-unsaturated fatty acid esters, epoxidized mono-unsaturated fatty alcohol esters, glycidyl amine compound(s), and combinations thereof.

Clause 76. The method of clause 75, wherein the aliphatic alcohol glycidyl ethers are selected from the group consisting of butyl glycidyl ether, 2-ethylhexyl glycidyl ether, C8-C10 alcohol glycidyl ethers, C12-C14 alcohol glycidyl ethers, and combinations thereof.

Clause 77. The method of clause 75, wherein the glycidyl esters of aliphatic carboxylic acids comprises a glycidyl ester of neodecanoic acid or rosin acid.

Clause 78. The method of clause 75, wherein the glycidyl esters of aromatic carboxylic acids comprises a glycidyl ester of benzoic acid.

Clause 79. The method of clause 75, wherein the aromatic glycidyl ethers are selected from the group consisting of phenyl glycidyl ether, (o,m,p)-cresol glycidyl ethers, p-tert butyl phenol glycidyl ether, cardanol based glycidyl ethers, and combinations thereof.

Clause 80. The method of any one of clauses 61-79, wherein the one or more anhydrides is selected from the group consisting of an aliphatic anhydride, an aromatic anhydride, and combinations thereof.

Clause 81. The method of any one of clauses 61-80, wherein the one or more anhydrides is selected from the group consisting of succinic anhydride, maleic anhydride, glutaric anhydride, phthalic anhydride, tetrahydrophthalic anhydride, hexahydrophthalic anhydride, methyl hexahydrophthalic anhydride, nadic anhydride, methyl nadic anhydride, naphthalic anhydride, trimellitic anhydride, diglycolic anhydride, and combinations thereof.

Clause 82. The method of clause 61-81, wherein the epoxy catalyst is selected from the group consisting of tertiary amines, tertiary phosphines, quaternary ammonium salts, quaternary phosphonium salts, imidazoles, dicyandiamide, lewis acids (boron trifluoride complexes), UV super acid complexes, organic acid hydrazides, alkali metal carboxylates, and combinations thereof.

Clause 83. The method of any one of clauses 61-82, wherein the polyester macromer is optionally further reacted with a cyclic ester to incorporate the ring opened cyclic ester into the polyester macromer, wherein the cyclic ester is selected from the group consisting of glycolide, lactide, α-acetolactone, β-propiolactone, γ-butyrolactone, δ-valerolactone, E-caprolactone, and combinations thereof.

Clause 84. The method of any one of clauses 61-83, further comprising a step of converting residual hydroxyl groups to esters after completion of the polymerization.

Clause 85. The method of any one of clauses 61-84, wherein the polyester macromer comprises an alternating copolymer comprising repeating (AB) units or (BA) units or a combination thereof, wherein (A) is an epoxide and (B) is an anhydride (B).

Clause 86. The method of clause 85, wherein the polyester macromer comprises up to 50 repeating (AB) units or (BA) units or a combination thereof.

Clause 87. The method of any one of clauses 61-86, wherein the polyester macromer is monounsaturated.

Clause 88. The method of any one of clauses 61-87, wherein the polyester macromer is terminally ethylenically unsaturated on one end only.

Clause 89. The method of any one of clauses 61-88, wherein the polyester macromer is solvent free.

Clause 90. The method of any one of clauses 61-89, wherein the weight average molecular weight (Mw) of the polyester macromer is within a range of from about 300 to about 20,000 g/mol as determined by gel permeation chromatography (GPC).

Clause 91. The method of any one of clauses 61-90, wherein the polyester macromer exhibits a glass transition temperature (Tg) within a range of from about −100° C. to about 150° C. measured by differential scanning calorimetry (DSC).

Clause 92. A method for producing a water-dispersible composition comprising:

providing the polyester macromer of any one of clauses 47-60 or the polyester macromer produced by the method of any one of clauses 61-91;

dissolving the polyester macromer in a monomer mixture to form a polymer-in-monomer solution, wherein the monomer mixture comprises one or more ethylenically unsaturated monomers;

combining the polymer-in-monomer solution with at least one surfactant, water, a neutralizing agent, and optionally one or more co-stabilizer to form a pre-emulsion; and

agitating the pre-emulsion under high shear to form a mini-emulsion, the mini-emulsion comprising an aqueous continuous phase and an organic disperse phase, the disperse phase being in the form of droplets having an average droplet diameter in the range of from about 50 to about 600 nanometers measured by Dynamic Light Scattering,

subjecting the mini-emulsion to free radical polymerization thereby copolymerizing the monomer mixture and the polyester macromer to form a polymer emulsion in which the polymer content is in the form of particles comprising an average particle diameter in the range of from about 50 to about 600 nanometers measured by Dynamic Light Scattering,

wherein the particles comprise the polyester macromer covalently bound to a (meth)acrylate polymer formed from copolymerizing the monomer mixture to produce a polyester-(meth)acrylate hybrid polymer, and

wherein the polyester macromer is present in the polyester-(meth)acrylate hybrid polymer at level of about 5% to about 95% by weight, based on the total weight of the polyester-(meth)acrylate hybrid polymer.

Clause 93. The method of clause 92, wherein the monomer mixture optionally comprises one or more tackifiers.

Clause 94. The method of clause 92 or 93, wherein the mini-emulsion optionally comprises one or more tackifiers post added to the mini-emulsion as a pre-dispersion.

Clause 95. The method of any one of clauses 92-94, wherein the tackifier in the monomer mixture is the same or different from the tackifier that is post added to the mini-emulsion.

Clause 96. The method of any one of clauses 92-95, wherein the polymer-in-monomer solution further comprises a monomer containing a photoinitiator moiety.

Clause 97. The method of clause 96, wherein the photoinitiator is selected from the group consisting of acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof.

Clause 98. The method of any one of clauses 96-97, wherein the photoinitiator is activatable upon exposure to UV radiation to at least partially polymerize and/or crosslink the polyester-(meth)acrylate hybrid polymer.

Clause 99. The method of any one of clauses 92-98, wherein the one or more ethylenically unsaturated monomers is selected from the group consisting of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, vinyl monomers, and combinations thereof.

Clause 100. The method of any one of clauses 92-99, wherein the one or more ethylenically unsaturated monomers is selected from the group consisting of acrylic acid, methacrylic acid, crotonic acid, crotonate esters, itaconic acid, itaconate esters, fumaric acid, fumarate esters, maleic acid, maleate esters, maleic anhydride, hydroxyl alkyl (meth)acrylate, hydroxyethyl (meth)acrylate, hydroxypropyl (meth)acrylate, glycidyl (meth)acrylate, (meth)acrylic anhydride, isobornyl (meth)acrylate, aminoethyl methacrylate, N,N-dimethyl aminoethyl methacrylate, urea/ureido methacrylate, acrylonitrile, methacrylonitrile, acrylamide, methacrylamide, N,N-dimethylacrylamide, methyl acrylate, methyl methacrylate, ethyl acrylate, ethyl methacrylate, butyl acrylate, butyl methacrylate, propyl acrylate, propyl methacrylate, 2-ethylhexyl acrylate, 2-ethylhexyl methacrylate, lauryl acrylate, lauryl methacrylate, iso-octyl acrylate, iso-octyl methacrylate, iso-decyl acrylate, iso-decyl methacrylate, stearyl acrylate, stearyl methacrylate, vinyl propionate, styrene, alkyl-substituted styrenes, vinyl acetate, vinyl chloride, N-vinyl pyrrolidone, and combinations thereof.

Clause 101. The method of any one of clauses 92-100, wherein the weight ratio of the polyester macromer to the (meth)acrylate copolymer is within the range of from about 5:95 to about 95:5 of the polyester-(meth)acrylate hybrid polymer.

Clause 102. The method of any one of clauses 92-101, wherein the weight ratio of the polyester macromer comprises a majority proportion of the polyester-(meth)acrylate hybrid polymer.

Clause 103. The method of any one of clauses 92-102, wherein the weight ratio of the polyester macromer to the (meth)acrylate copolymer is within the range of from about 50:50 to about 95:5 of the polyester-(meth)acrylate hybrid polymer.

Clause 104. The method of any one of clauses 92-103, wherein the weight ratio of the polyester macromer to the (meth)acrylate copolymer is within the range of from about 70:30 to about 95:5 of the polyester-(meth)acrylate hybrid polymer.

Clause 105. The method of any one of clauses 92-104, wherein the composition further comprises additives selected from the group consisting of pigments, fillers, plasticizers, diluents, antioxidants, waxes, tackifiers, crosslinkers, and combinations thereof.

Clause 106. The method of any one of clauses 92-105, wherein the polyester-(meth)acrylate hybrid polymer exhibits a single glass transition temperature (Tg) within a range of from about −100° C. to about 150° C. measured by differential scanning calorimetry (DSC).

Clause 107. The method of any one of clauses 92-105, wherein the polyester macromer and the (meth)acrylate polymer are phase separated.

Clause 108. The method of clause 107, wherein the polyester-(meth)acrylate hybrid polymer exhibits at least two glass transition temperatures (Tgs) within a range of from about −100° C. to about 150° C. measured by differential scanning calorimetry (DSC).

Clause 109. The method of any one of clauses 92-108, wherein the weight average molecular weight (Mw) of the polyester-(meth)acrylate hybrid polymer is within a range of from about 5,000 to about 1,000,000 g/mol as determined by gel permeation chromatography (GPC).

Clause 110. The method of any one of clauses 92-109, further comprising the step of crosslinking the polyester-(meth)acrylate hybrid polymer to form a pressure sensitive adhesive.

Clause 111. The method of clause 110, wherein the pressure sensitive adhesive exhibits a plateau shear modulus at 25° C. and 1 radian per second that is between 5×10⁴ and 6×10⁶ dynes/cm² as determined by dynamic mechanical analysis (DMA).

Clause 112. The method of clause 110 or 111, wherein the pressure sensitive adhesive exhibits one or two glass transition temperatures (Tgs) within a range of from about −100° C. to about 150° C. measured by differential scanning calorimetry (DSC).

Clause 113. A method for producing a solvent-based polyester-(meth)acrylate hybrid polymer composition comprising:

providing a (meth)acrylate polymer optionally dissolved in an aprotic solvent, the (meth)acrylate polymer containing an acid and/or an alcohol functional group on the polymer backbone;

copolymerizing the (meth)acrylate polymer with one or more epoxides, one or more anhydrides, an epoxy catalyst, and optionally a free radical inhibitor to form the polyester-(meth)acrylate hybrid polymer,

wherein the step of copolymerizing comprises growing a side chain polyester oligomer off of the (meth)acrylate polymer, and

wherein the polyester oligomer is present in the polyester-(meth)acrylate hybrid polymer at level of about 5% to about 95% by weight, based on the total weight of the polyester-(meth)acrylate hybrid polymer.

Clause 114. The method of clause 113, wherein the composition optionally comprises one or more tackifiers.

Clause 115. The method of clause 113 or 114, wherein the (meth)acrylate polymer is prepared by copolymerizing at least one of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, and vinyl monomers, optionally dissolved in an aprotic solvent.

Clause 116. The method of any one of clauses 113-115, wherein the (meth)acrylate polymer is prepared by copolymerizing at least one monomer selected from the group consisting of acrylic acid, methacrylic acid, crotonic acid, crotonate esters, itaconic acid, itaconate esters, fumaric acid, fumarate esters, maleic acid, maleate esters, maleic anhydride, hydroxyl alkyl (meth)acrylate, hydroxyethyl (meth)acrylate, hydroxypropyl (meth)acrylate, hydroxybutyl (meth)acrylate, glycidyl (meth)acrylate, (meth)acrylic anhydride, isobornyl (meth)acrylate, aminoethyl methacrylate, N,N-dimethyl aminoethyl methacrylate, urea/ureido methacrylate, acrylonitrile, methacrylonitrile, acrylamide, methacrylamide, N,N-dimethylacrylamide, methyl acrylate, methyl methacrylate, ethyl acrylate, ethyl methacrylate, butyl acrylate, butyl methacrylate, propyl acrylate, propyl methacrylate, 2-ethylhexyl acrylate, 2-ethylhexyl methacrylate, lauryl acrylate, lauryl methacrylate, iso-octyl acrylate, iso-octyl methacrylate, iso-decyl acrylate, iso-decyl methacrylate, stearyl acrylate, stearyl methacrylate, vinyl propionate, styrene, alkyl-substituted styrenes, vinyl acetate, vinyl chloride, and N-vinyl pyrrolidone, optionally dissolved in an aprotic solvent.

Clause 117. The method of any one of clauses 113-116, wherein the (meth)acrylate hybrid polymer contains a photoinitiator moiety in the form of a distinct agent that is added to the composition, or a photoinitiator moiety bound to the polymer backbone, or a photoinitiator moiety formed in-situ by an association of materials or agents in the composition.

Clause 118. The method of clause 117, wherein the photoinitiator is selected from the group consisting of acetophenone, an acetophenone derivative, benzophenone, a benzophenone derivative, anthraquinone, an anthraquinone derivative, benzile, a benzile derivative, thioxanthone, a thioxanthone derivative, xanthone, a xanthone derivative, a benzoin ether, a benzoin ether derivative, an alpha-ketol, an alpha-ketol derivative, and combinations thereof.

Clause 119. The method of any one of clauses 117-118, wherein the photoinitiator is activatable upon exposure to UV radiation to at least partially polymerize and/or crosslink the polyester-(meth)acrylate hybrid polymer.

Clause 120. The method of any one of clauses 113-119, wherein the weight ratio of the polyester oligomer to the (meth)acrylate copolymer is within the range of from about 5:95 to about 95:5 of the polyester-(meth)acrylate hybrid polymer.

Clause 121. The method of any one of clauses 113-120, wherein the weight ratio of the polyester macromer comprises a majority proportion of the polyester-(meth)acrylate hybrid polymer.

Clause 122. The method of any one of clauses 113-121, wherein the weight ratio of the polyester oligomer to the (meth)acrylate copolymer is within the range of from about 50:50 to about 95:5 of the polyester-(meth)acrylate hybrid polymer.

Clause 123. The method of any one of clauses 113-122, wherein the weight ratio of the polyester oligomer to the (meth)acrylate copolymer is within the range of from about 70:30 to about 95:5 of the polyester-(meth)acrylate hybrid polymer.

Clause 124. The method of any one of clauses 113-123, wherein the polyester oligomer comprises an alternating copolymer comprising repeating (AB) units or (BA) units or a combination thereof, wherein (A) is an epoxide and (B) is an anhydride (B).

Clause 125. The method of clause 124, wherein the polyester oligomer comprises up to 50 repeating (AB) units or (BA) units or a combination thereof.

Clause 126. The method of any one of clauses 113-125, wherein the one or more epoxides comprises a monoepoxide.

Clause 127. The method of any one of clauses 113-126, wherein the one or more epoxides is a compound selected from the group consisting of aliphatic alcohol glycidyl ethers having 1 to 22 carbon atoms, glycidyl esters of aliphatic carboxylic acids containing from 1 to 22 carbon atoms, glycidyl esters of aromatic carboxylic acids, alkyl substituted glycidyl esters of aromatic carboxylic acids, aryl substituted glycidyl esters of aromatic carboxylic acids, aromatic glycidyl ethers, alkyl substituted aromatic glycidyl ethers, aryl substituted aromatic glycidyl ethers, terpene based mono-epoxides, alpha olefin based mono-epoxides, oxetane, alkylated derivatives of oxetanes, epoxidized mono-unsaturated fatty acid esters, epoxidized mono-unsaturated fatty alcohol esters, glycidyl amine compound(s), and combinations thereof.

Clause 128. The method of clause 127, wherein the aliphatic alcohol glycidyl ethers are selected from the group consisting of butyl glycidyl ether, 2-ethylhexyl glycidyl ether, C8-C10 alcohol glycidyl ethers, C12-C14 alcohol glycidyl ethers, and combinations thereof.

Clause 129. The method of clause 127, wherein the glycidyl esters of aliphatic carboxylic acids comprises a glycidyl ester of at least one of neodecanoic acid, acrylic acid, methacrylic acid, and rosin acid.

Clause 130. The method of clause 127, wherein the glycidyl esters of aromatic carboxylic acids comprises a glycidyl ester of benzoic acid.

Clause 131. The method of clause 127, wherein the aromatic glycidyl ethers are selected from the group consisting of phenyl glycidyl ether, (o,m,p)-cresol glycidyl ethers, p-tert butyl phenol glycidyl ether, cardanol based glycidyl ethers, and combinations thereof.

Clause 132. The method of any one of clauses 113-131, wherein the one or more anhydrides is selected from the group consisting of an aliphatic anhydride, an aromatic anhydride, and combinations thereof.

Clause 133. The method of any one of clauses 113-132, wherein the one or more anhydrides is selected from the group consisting of succinic anhydride, maleic anhydride, glutaric anhydride, phthalic anhydride, tetrahydrophthalic anhydride, hexahydrophthalic anhydride, methyl hexahydrophthalic anhydride, nadic anhydride, methyl nadic anhydride, naphthalic anhydride, trimellitic anhydride, diglycolic anhydride, and combinations thereof.

Clause 134. The method of any one of clauses 113-133, wherein the epoxy catalyst is selected from the group consisting of tertiary amines, tertiary phosphines, quaternary ammonium salts, quaternary phosphonium salts, imidazoles, dicyandiamide, lewis acids (boron trifluoride complexes), UV super acid complexes, organic acid hydrazides, alkali metal carboxylates, and combinations thereof.

Clause 135. The method of any one of clauses 113-134, wherein the polyester oligomer is optionally further reacted with a cyclic ester to incorporate the ring opened cyclic ester into the polyester macromer, wherein the cyclic ester is selected from the group consisting of glycolide, lactide, α-acetolactone, β-propiolactone, γ-butyrolactone, δ-valerolactone, E-caprolactone, and combinations thereof.

Clause 136. The method of any one of clauses 113-135, further comprising a step of converting residual hydroxyl groups to esters after completion of the polymerization.

Clause 137. The method of any one of clauses 113-136, wherein the composition further comprises additives selected from the group consisting of pigments, fillers, plasticizers, diluents, antioxidants, waxes, tackifiers, crosslinkers, and combinations thereof.

Clause 138. The method of any one of clauses 113-137, wherein the (meth)acrylate polymer exhibits a glass transition temperature (Tg) within a range of from about −100° C. to about 150° C. measured by differential scanning calorimetry (DSC).

Clause 139. The method of any one of clauses 113-138, wherein the weight average molecular weight (Mw) of the (meth)acrylate polymer is within a range of from about 5,000 to about 1,000,000 g/mol as determined by gel permeation chromatography (GPC).

Clause 140. The method of any one of clauses 113-139, wherein the polyester-(meth)acrylate hybrid polymer exhibits a single glass transition temperature (Tg) within a range of from about −100° C. to about 150° C. measured by differential scanning calorimetry (DSC).

Clause 141. The method of any one of clauses 113-139, wherein the polyester oligomer and the (meth)acrylate polymer are phase separated.

Clause 142. The method of clause 141, wherein the polyester-(meth)acrylate hybrid polymer exhibits at least two glass transition temperatures (Tgs) within a range of from about −100° C. to about 150° C. measured by differential scanning calorimetry (DSC).

Clause 143. The method of any one of clauses 113-142, wherein the weight average molecular weight (Mw) of the polyester-(meth)acrylate hybrid polymer is within a range of from about 5,000 to about 1,000,000 g/mol as determined by gel permeation chromatography (GPC).

Clause 144. The method of any one of clauses 113-143, further comprising the step of crosslinking the polyester-(meth)acrylate hybrid polymer to form a pressure sensitive adhesive.

Clause 145. The method of clause 144, wherein the pressure sensitive adhesive exhibits a plateau shear modulus at 25° C. and 1 radian per second that is between 5×10⁴ and 6×10⁶ dynes/cm² as determined by dynamic mechanical analysis (DMA).

Clause 146. The method of clause 144 or 145, wherein the pressure sensitive adhesive exhibits one or two glass transition temperature (Tg) within a range of from about −100° C. to about 150° C. measured by differential scanning calorimetry (DSC).

The features, structures, or characteristics of the invention described throughout this specification may be combined in any suitable manner in one or more aspects. For example, reference throughout this specification to “certain aspects,” “some aspects,” or similar language means that a particular feature, structure, or characteristic described in connection with the aspect is included in at least one aspect of the present invention. Thus, appearances of the phrases “in certain aspects,” “in some aspect,” “in other aspects,” or similar language throughout this specification do not necessarily all refer to the same group of aspects and the described features, structures, or characteristics may be combined in any suitable manner in one or more aspects.

As described hereinabove, the present subject matter solves many problems associated with previous strategies, systems and/or devices. However, it will be appreciated that various changes in the details, materials and arrangements of components and/or operations, which have been herein described and illustrated in order to explain the nature of the present subject matter, may be made by those skilled in the art without departing from the principle and scope of the claimed subject matter, as expressed in the appended claims.

1. A polyester-(meth)acrylate hybrid polymer composition comprising:
a polyester portion covalently bound to a (meth)acrylate portion, the polyester portion comprising an alternating copolymer comprising repeating (AB) units or (BA) units or a combination thereof, wherein (A) is an epoxide and (B) is an anhydride (B), and the (meth)acrylate portion comprising a (meth)acrylate polymer,
wherein the polyester portion is present in the polyester-(meth)acrylate hybrid polymer at a level of about 5% to about 95% by weight, based on the total weight of the polyester-(meth)acrylate hybrid polymer.

2. The composition of claim 1, wherein the polyester portion comprises up to 50 repeating (AB) or (BA) units or a combination thereof.

3. The composition of claim 1, wherein the weight ratio of the polyester portion to the (meth)acrylate portion is within the range of from about 5:95 to about 95:5 of the polyester-(meth)acrylate hybrid polymer.

4. The composition of claim 1, wherein the weight ratio of the polyester portion to the (meth)acrylate portion is within the range of from about 50:50 to about 95:5 of the polyester-(meth)acrylate hybrid polymer.

5. The composition of claim 1, wherein the weight ratio of the polyester portion to the (meth)acrylate portion is within the range of from about 70:30 to about 95:5 of the polyester-(meth)acrylate hybrid polymer.

6. The composition of claim 1, further comprising one or more tackifiers.

7. The composition of claim 1 comprising
about 50-95 wt % polyester portion;
about 5-50 wt % (meth)acrylate portion; and
about 0-50 wt % one or more tackifiers,
wherein the weight % of the components sum up to a total of 100% based on the total weight of the polyester-(meth)acrylate hybrid polymer composition.

8. The composition of claim 1, wherein the polyester portion comprises units that are a reaction product of one or more ethylenically unsaturated monomers, one or more epoxides, and one or more anhydrides.

9. The composition of claim 8, wherein the one or more ethylenically unsaturated monomers comprise an α,β-unsaturated monomer.

10. The composition of claim 8, wherein the one or more epoxides comprises a monoepoxide.

11. The composition of claim 8, wherein the one or more anhydrides is selected from the group consisting of an aliphatic anhydride, an aromatic anhydride, and combinations thereof.

12. The composition of claim 1, wherein the weight average molecular weight (Mw) of the polyester portion is within a range of from about 300 to about 20,000 g/mol as determined by gel permeation chromatography (GPC).

13. The composition of claim 1, wherein the polyester portion exhibits a glass transition temperature (Tg) within a range of from about −100° C. to about 150° C. measured by differential scanning calorimetry (DSC).

14. The composition of claim 1, wherein the polyester portion comprises a polyester macromer or a polyester oligomer.

15. The composition of claim 1, wherein the polyester portion contains one terminal ethylenically unsaturated group.

16. The composition of claim 1, wherein the (meth)acrylate polymer is prepared from at least one of acrylic acid, acrylates comprising C1 to about C20 alkyl, aryl, aralkyl, or cyclic acrylates, acrylamides comprising C1 to about C20 alkyl, aryl, aralkyl, or cyclic acrylamides, methacrylic acid, methacrylates comprising C1 to about C20 alkyl, aryl, aralkyl, or cyclic methacrylates, methacrylamides comprising C1 to about C20 alkyl, aryl, aralkyl, or cyclic methacrylamides, and vinyl monomers.

17. The composition of claim 1, wherein the polyester-(meth)acrylate hybrid polymer contains a photoinitiator moiety in the form of a distinct agent that is added to the composition, or a photoinitiator moiety bound to the polymer backbone, or a photoinitiator moiety formed in-situ by an association of materials or agents in the composition.

18. The composition of claim 17, wherein the photoinitiator is activatable upon exposure to UV radiation to at least partially polymerize and/or crosslink the composition.

19. The composition of claim 1, wherein the (meth)acrylate polymer exhibits a glass transition temperature (Tg) within a range of from about −100° C. to about 150° C. measured by differential scanning calorimetry (DSC).

20. The composition of claim 1, wherein the weight average molecular weight (Mw) of the (meth)acrylate polymer is within a range of from about 5,000 to about 1,000,000 g/mol as determined by gel permeation chromatography (GPC).

21. The composition of claim 1, wherein the polyester-(meth)acrylate hybrid polymer exhibits a single glass transition temperature (Tg) within a range of from about −100° C. to about 150° C. measured by differential scanning calorimetry (DSC).

22. The composition of claim 1, wherein the polyester portion and the (meth)acrylate portion are phase separated.

23. The composition of claim 22, wherein the polyester-(meth)acrylate hybrid polymer exhibits at least two glass transition temperatures (Tgs) within a range of from about −100° C. to about 150° C. measured by differential scanning calorimetry (DSC).

24. The composition of claim 1, wherein the weight average molecular weight (Mw) of the polyester-(meth)acrylate hybrid polymer is within a range of from about 5,000 to about 1,000,000 g/mol as determined by gel permeation chromatography (GPC).

25. A solvent-based polyester-(meth)acrylate hybrid polymer composition comprising:
the polyester-(meth)acrylate hybrid polymer composition of claim 1, wherein the polyester-(meth)acrylate hybrid polymer comprises a reaction product of the (meth)acrylate polymer optionally dissolved in an aprotic solvent, the one more epoxides, the one or more anhydrides, an epoxy catalyst, and optionally a free radical inhibitor to form a side chain of the polyester oligomer covalently bound to the (meth)acrylate polymer, wherein the (meth)acrylate polymer contains an acid and/or an alcohol functional group on the polymer backbone.

26. A water-dispersible composition comprising:
particles comprising the polyester-(meth)acrylate hybrid polymer according to claim 1,
wherein the polyester-(meth)acrylate hybrid polymer comprises a reaction product of the polyester macromer and at least one ethylenically unsaturated monomer, wherein the reaction is a free radical polymerization reaction.

27. The composition of claim 26, wherein the average particle size diameter is in the range of about 50 nm to about 600 nm measured by Dynamic Light Scattering.

28. A pressure sensitive adhesive comprising the composition of claim 1 and one or more crosslinkers.

29.-30. (canceled)

31. A polyester macromer comprising:
an alternating copolymer comprising up to 50 repeating (AB) units or (BA) units or a combination thereof, wherein (A) is an epoxide and (B) is an anhydride (B), and the (meth)acrylate portion comprising a (meth)acrylate polymer,
wherein the repeating units are a reaction product of one or more ethylenically unsaturated monomers, one or more epoxides, one or more anhydrides, an epoxy catalyst, and optionally a free radical inhibitor.

32.-37. (canceled)

38. A method for producing a polyester macromer comprising:
polymerizing a monomer mixture comprising one or more ethylenically unsaturated monomers, one or more epoxides, one or more anhydrides, an epoxy catalyst, and optionally a free radical inhibitor to form a terminally ethylenically unsaturated polyester macromer copolymer.

39.-46. (canceled)

47. A method for producing a water-dispersible composition comprising:
providing the polyester macromer of claim 31;
dissolving the polyester macromer in a monomer mixture to form a polymer-in-monomer solution, wherein the monomer mixture comprises one or more ethylenically unsaturated monomers;
combining the polymer-in-monomer solution with at least one surfactant, water, a neutralizing agent, and optionally one or more co-stabilizer to form a pre-emulsion; and
agitating the pre-emulsion under high shear to form a mini-emulsion, the mini-emulsion comprising an aqueous continuous phase and an organic disperse phase, the disperse phase being in the form of droplets having an average droplet diameter in the range of from about 50 to about 600 nanometers measured by Dynamic Light Scattering,
subjecting the mini-emulsion to free radical polymerization thereby copolymerizing the monomer mixture and the polyester macromer to form a polymer emulsion in which the polymer content is in the form of particles comprising an average particle diameter in the range of from about 50 to about 600 nanometers measured by Dynamic Light Scattering,
wherein the particles comprise the polyester macromer covalently bound to a (meth)acrylate polymer formed from copolymerizing the monomer mixture to produce a polyester-(meth)acrylate hybrid polymer, and
wherein the polyester macromer is present in the polyester-(meth)acrylate hybrid polymer at level of about 5% to about 95% by weight, based on the total weight of the polyester-(meth)acrylate hybrid polymer.

48.-53. (canceled)

54. A method for producing a solvent-based polyester-(meth)acrylate hybrid polymer composition comprising:
providing a (meth)acrylate polymer optionally dissolved in an aprotic solvent, the (meth)acrylate polymer containing an acid and/or an alcohol functional group on the polymer backbone;
copolymerizing the (meth)acrylate polymer with one or more epoxides, one or more anhydrides, an epoxy catalyst, and optionally a free radical inhibitor to form the polyester-(meth)acrylate hybrid polymer,
wherein the step of copolymerizing comprises growing a side chain polyester oligomer off of the (meth)acrylate polymer, and
wherein the polyester oligomer is present in the polyester-(meth)acrylate hybrid polymer at level of about 5% to about 95% by weight, based on the total weight of the polyester-(meth)acrylate hybrid polymer.

55.-59. (canceled)

60. A method for producing a water-dispersible composition comprising:
providing the polyester macromer produced by the method of claim 38;
dissolving the polyester macromer in a monomer mixture to form a polymer-in-monomer solution, wherein the monomer mixture comprises one or more ethylenically unsaturated monomers;
combining the polymer-in-monomer solution with at least one surfactant, water, a neutralizing agent, and optionally one or more co-stabilizer to form a pre-emulsion; and
agitating the pre-emulsion under high shear to form a mini-emulsion, the mini-emulsion comprising an aqueous continuous phase and an organic disperse phase, the disperse phase being in the form of droplets having an average droplet diameter in the range of from about 50 to about 600 nanometers measured by Dynamic Light Scattering,
subjecting the mini-emulsion to free radical polymerization thereby copolymerizing the monomer mixture and the polyester macromer to form a polymer emulsion in which the polymer content is in the form of particles comprising an average particle diameter in the range of from about 50 to about 600 nanometers measured by Dynamic Light Scattering,
wherein the particles comprise the polyester macromer covalently bound to a (meth)acrylate polymer formed from copolymerizing the monomer mixture to produce a polyester-(meth)acrylate hybrid polymer, and
wherein the polyester macromer is present in the polyester-(meth)acrylate hybrid polymer at level of about 5% to about 95% by weight, based on the total weight of the polyester-(meth)acrylate hybrid polymer.
